(19) United States
(12) Patent Application Publication
(10) Pub. No.: US 2005/0178821 A1
(43) Pub. Date: Aug. 18, 2005

(54) Manual providing apparatus, multi function printer, server, electronic manual presentation method, and computer program

(76) Inventors: Yuji Ono, Kawasaki (JP); Hiroyuki Sakuyama, Tokyo (JP)

Correspondence Address: MORRISON & FOERSTER LLP, 1650 TYSONS BOULEVARD, SUITE 300, MCLEAN, VA, 22102, US

(21) Appl. No.: 11/060,393

(22) Filed: Feb. 17, 2005

(30) Foreign Application Priority Data
Feb. 18, 2004 (JP) 2004-41073

(51) Int. Cl. G06F 17/00

(52) U.S. Cl. 235/375

(57) ABSTRACT

The MFP accepts user's demands regarding output format of electronic manuals. The MFP obtains electronic manual data representing manual desired by the user, and processes the electronic manual data in accordance with the user's demands. The movie data includes guidance data corresponding to frames of the movie. The MFP displays the movie with or without the guidance data in accordance with the user's demands. In this case, the MFP arranges language, layout, and the like of the guidance data in accordance with the user's demands. Or, the MFP extracts predetermined frame images and corresponding guidance data, and generates print format in accordance with the user's demands. In this case, the MFP arranges layouts of frame images or guidance text, langrage of the guidance text, and the like in accordance with the user's demands. Thus, the electronic manuals are output flexibly in accordance with the user's demands.

### BACKGROUND OF THE INVENTION

1. Field of the Invention

The present invention relates to a manual providing apparatus, a multi function printer (MFP), a server, an electronic manual presentation method, and a computer program, more particularly to a manual providing apparatus, a multi function printer (MFP), a server, an electronic manual presentation method, and a computer program for presenting manuals with using movie data.

2. Description of the Related Art

Conventionally, paper base manuals have been popular and typical. Recently, electronic manuals have spread in view of increase of contents or paper saving. For example, Unexamined Japanese Patent Application KOKAI Publication No. 2002-149874 discloses a system for providing such the electronic manuals. Instead of the paper base manuals, the electronic manuals have many advantageous merits. For example, since contents of manuals are digitized, it is easy to distribute the manuals via telecommunications network such as the Internet. Additionally, it is also easy to update or revise.

Digital motion pictures (movie) or still pictures (still images) are available on the electronic manuals. This is another significant merit of the electronic manuals. Still images are suitable for showing highlight scene in a series of actions or close-up of a device, and the like. On the contrary, movie image is suitable for showing a series of actions. Thus, those different image styles have advantages and disadvantages respectively. For example, though a still image base manual is helpful for understanding specific actions or details of an object, it is unfamiliar with showing actions in series. On the other hand, though a movie base manual is useful for comprehensively showing actions in series, it is not suitable for detailed explanation because the explanation tends to be stereotyped.

If the output format is flexibly selectable by a user in accordance with the user's demands or the like, the electronic manual will be more user-friendly media. However, such the flexibility is not available by the conventional techniques, because output formats of the electronic manuals are fixed by the provider.

The present invention has been made as a solution for the above problems, and it is an object of the present invention to present a manual providing apparatus, an MFP, a server, an electronic manual presentation method, and a computer program by which a user is able to get manuals with preferable output format.

### SUMMARY OF THE INVENTION

To achieve the above objects, a manual providing apparatus according to a first aspect of the present invention is a manual providing apparatus for providing electronic manuals, comprises:
a manual data retriever which obtains electronic manual data including movie data;
a designation acceptor which accepts user's designation regarding output format of the manual;
a manual data processor which processes the electronic manual data obtained by the manual data retriever in accordance with the designated output format; and
a manual output unit which outputs the electronic manual data processed by the manual data processor.

The manual providing apparatus may further comprise a database which previously stores the electronic manual data, wherein
the manual data retriever may obtain the electronic manual data from the database.

In the manual providing apparatus,
the manual data processor may extract predetermined frame images from movie frames of the electronic manual data, and
the manual output unit may output the manual by printing the frame images extracted by the manual data processor.

In the manual providing apparatus,
the electronic manual data may include guidance data frame by frame, and
the manual data processor may extract frames including the guidance data.

In the manual providing apparatus,
the manual data retriever may further comprise a layout data retriever which obtains layout data, and
the manual data processor may process the electronic manual data based on the layout data obtained by the layout data retriever.

In the manual providing apparatus,
the manual data retriever may obtain the electronic manual data from an external apparatus via a network.

The manual providing apparatus may further comprise a user authenticator which carries out user authentication in accordance with the designated manual.

In the manual providing apparatus, the manual providing apparatus may comprise an image forming apparatus.

In the manual providing apparatus, the manual providing apparatus may comprise a multi function printer (MFP).

In the manual providing apparatus, the output unit may output the electronic manual data to an external apparatus via a network.

To achieve the above objects, a manual providing apparatus according to a second aspect of the present invention is a manual providing apparatus for providing electronic manuals, which comprises:
database means for storing electronic manual data including movie data;
accept means for accepting user's demands regarding the electronic manuals;
manual specifying means for specifying electronic manual in accordance with the user's demands;
manual data processing means for processing the electronic manual data representing the electronic manual specified by the manual specifying means in accordance with the user's demands;
display means for displaying the movie in the specified electronic manual data in accordance with the user's demands; and
print means for printing the specified electronic manual in accordance with the user's demands.

In the manual providing apparatus,
the movie data included in the electronic manual data may include predetermined guidance data, and
the display means may output the guidance data while displaying the movie in accordance with the user's demands.

In the manual providing apparatus, the print means may extract frame images from the movie data in the specified electronic manual data in accordance with the user's demands.

To achieve the above objects, a multi function printer (MFP) according to a third aspect of the present invention comprises:
a manual data retriever which obtains electronic manual data including movie data and guidance data;
a designation acceptor which accepts user's designation regarding output format of the electronic manual;
a display unit which displays the movie of the electronic manual obtained by the manual data retriever;
a manual data processor which extracts predetermined frame images and guidance data from the movie data of the electronic manual data obtained by the manual data retriever in accordance with output format designated by the user; and
a printer which prints the electronic manual represented by the electronic manual data processed by the manual data processor.

The multi function printer (MFP) may further comprise a database which stores the electronic manual data.

To achieve the above objects, a server according to a fourth aspect of the present invention comprises:
a database which stores electronic manual data including movie data and guidance data;
a receiver which receives information representing user's demands from a terminal via a network;
a manual data retriever which specifies electronic manual based on the user's demands, and obtains electronic manual data representing the specified electronic manual from the database;
a manual data processor which processes the manual data obtained by the manual data retriever in accordance with the user's demands; and
a transmitter which transmits the electronic manual data processed by the manual data processor to the terminal via the network.

In the server,
the database may further store layout data for regulating layout pattern for printing the electronic manual, and
the manual data processor may extract predetermined frame images and corresponding guidance data from the movie data in the specified electronic manual data, obtains layout data representing layout pattern corresponding to the user's demands from the database, and processes the extracted frame images and guidance data based on the obtained layout data.

In the server,
the database may further store information regarding users, information regarding equipment used by the users, and electronic manual data representing manuals regarding the equipment, being associated with each other, and the manual data retriever may specify the manual to be presented to a user based on information regarding the user concerned, and obtains the electronic manual data representing the specified manual.

To achieve the above objects, a method according to a fifth aspect of the present invention is a method for presenting electronic manuals with using a computer, which comprises the steps of:
obtaining electronic manual data including movie data and guidance data prepared in each of frames in the movie data from a predetermined database;
accepting user's demands regarding output format of the electronic manual;
displaying the movie included in the electronic manual data in accordance with the user's demands; and
extracting predetermined frame images and corresponding guidance data from the movie data in accordance with the user's demands to print out the electronic manual in accordance with layout corresponding to the user's demands.

To achieve the above objects, a computer program product according to a sixth aspect of the present invention is a computer program product including a computer program for causing a computer to act as a terminal computer for providing electronic manuals which comprises functions of:
obtaining electronic manual data including movie data and guidance data corresponding to frames in the movie data from a predetermined database;
accepting user's demands regarding output formats of the electronic manuals;
displaying the movie represented by the movie data in the obtained electronic manual data in accordance with the user's demands; and
extracting predetermined frame images and corresponding guidance data from the movie data in the obtained electronic manual data in accordance with the user's demands, and printing the extracted data in accordance with layout corresponding to the user's demands.

The computer program included in the computer program product may further cause the computer to comprise a database function for storing the electronic manual data.

To achieve the above, objects, a computer data signal according to a seventh aspect of the present invention is a computer data signal embodied in a carrier wave for causing a computer to act as a terminal computer for providing electronic manuals which comprises functions of:
obtaining electronic manual data including movie data and guidance data corresponding to frames in the movie data from a predetermined database;
accepting user's demands regarding output formats of the electronic manuals;
displaying the movie represented by the movie data in the obtained electronic manual data in accordance with the user's demands; and
extracting predetermined frame images and corresponding guidance data from the movie data in the obtained electronic manual data in accordance with the user's demands, and printing the extracted data in accordance with layout corresponding to the user's demands.

The computer data signal may further cause the computer to comprise a database function for storing the electronic manual data.

To achieve the above objects, a compute program product according to an eighth aspect of the present invention is a computer program product including a computer program for causing a computer to act as a server computer for providing electronic manuals which comprises the functions of:
storing electronic manual data including movie data and guidance data;
receiving information representing user's demands from a user terminal via a network;
specifying manual based on the user's demands, and obtaining electronic manual data representing the specified manual from the stored electronic manual data;
processing the obtained electronic manual data based on the user's demands; and
transmitting the processed electronic manual data to the user terminal via the network.

The computer program included in the computer program may cause the computer to further comprise functions of:
storing layout data regulating layout patterns for printing the electronic manuals;
extracting predetermined frame images and corresponding guidance data from the movie data included in the obtained electronic manual data in accordance with the user's demands;
obtaining layout data representing layout pattern corresponding to the user's demands; and
processing the extracted frame images and corresponding guidance data based on the obtained layout data.

To achieve the above objects, a computer data signal according to a ninth aspect of the present invention is a computer data signal embodied in a carrier wave for causing a computer to act as a server computer for providing electronic manuals which comprises functions of:
storing electronic manual data including movie data and guidance data;
receiving information representing user's demands from a user terminal via a network;
specifying manual based on the user's demands, and obtaining electronic manual data representing the specified manual from the stored electronic manual data;
processing the obtained electronic manual data based on the user's demands; and
transmitting the processed electronic manual data to the user terminal via the network.

The computer data signal may cause the computer to further comprise the functions of:
storing layout data regulating layout patterns for printing the electronic manuals;
extracting predetermined frame images and corresponding guidance data from the movie data included in the obtained electronic manual data in accordance with the user's demands;
obtaining layout data representing layout pattern corresponding to the user's demands; and
processing the extracted frame images and corresponding guidance data based on the obtained layout data.

### BRIEF DESCRIPTION OF THE DRAWINGS

These objects and other objects and advantages of the present invention will become more apparent upon reading of the following detailed description and the accompanying drawings in which:

FIG. 1 is an exterior view of an MFP according to the first and second embodiments of the present invention to show the external structure of the MFP;

FIG. 2 is a block diagram showing the internal structure of the MFP shown in FIG. 1;

FIG. 3 is a schematic diagram exemplifying the structure of storage unit shown in FIG. 1;

FIG. 4 is a diagram exemplifying data recorded in a manual DB shown in FIG. 3;

FIG. 5 is a diagram for explaining the data structure of the manual data stored in the manual DB;

FIG. 6 is a diagram exemplifying data recorded in a user information DB shown in FIG. 3;

FIG. 7 is a diagram exemplifying data recorded in a layout DB shown in FIG. 3;

FIG. 8 is a flowchart for explaining “E-Manual Presentation Process” according to the first embodiment of the present invention;

FIG. 9A is a diagram exemplifying a function selector screen displayed through the e-manual presentation process shown in FIG. 8;

FIG. 9B is a diagram exemplifying a category selector screen displayed through the e-manual presentation process shown in FIG. 8;

FIG. 9C is a diagram exemplifying another category selector screen displayed through the e-manual presentation process shown in FIG. 8;

FIG. 10A is a diagram exemplifying an output format selector screen displayed through the e-manual presentation process shown in FIG. 8;

FIG. 10B is a diagram exemplifying another output format selector screen displayed through the e-manual presentation process shown in FIG. 8;

FIG. 10C is a diagram exemplifying still another output format selector screen displayed through the e-manual presentation process shown in FIG. 8;

FIG. 11A is a diagram showing a sample of the e-manual as movie format output through the e-manual presentation process shown in FIG. 8;

FIG. 11B is a diagram showing another sample of the e-manual as print format output through the e-manual presentation process shown in FIG. 8;

FIG. 12 is a diagram showing the structure of the storage unit of the MFP according to the second embodiment of the present invention;

FIG. 13A is a diagram for explaining the movie data coding according to the second embodiment of the present invention;

FIG. 13B is a diagram for explaining data embedded in the movie data according to the second embodiment of the present invention;

FIG. 14 is a diagram exemplifying data stored in the user information DB shown in FIG. 12 according to the second embodiment of the present invention;

FIG. 15 is a flowchart for explaining “E-Manual Output Process” according to the second embodiment of the present invention;

FIGS. 16A and 16B are diagrams showing samples of displayed screens according to the second embodiment of the present invention;

FIGS. 17A and 17B are diagrams showing samples of displayed screens according to the second embodiment of the present invention;

FIG. 18A is a diagram for explaining the structure of contents to be shown as a manual according to the second embodiment of the present invention;

FIG. 18B is a diagram exemplifying a display image of the electronic manual as movie format;

FIGS. 19A and 19B are diagrams showing sample display images for setting the output format according to the second embodiment of the present invention;

FIG. 20 is a flowchart for explaining “Manual Image Generating Process” according to the second embodiment of the present invention;

FIG. 21 is a diagram for explaining output format regarding the number of frames for printing according to the embodiments of the present invention;

FIGS. 22A and 22B are diagrams for explaining output format regarding text layout for printing according to the embodiments of the present invention;

FIGS. 23A and 23B are diagrams for explaining output format regarding the number of frames and text layout for printing according to the embodiments of the present invention;

FIGS. 24A and 24B are diagrams for explaining output format regarding languages for printing according to the embodiments of the present invention;

FIGS. 25A and 25B are diagrams for explaining output format regarding text layout for printing according to the embodiments of the present invention;

FIGS. 26A and 26B are diagrams for explaining output format regarding text size for printing according to the embodiments of the present invention;

FIG. 27 is a schematic view showing the structure of a manual providing system according to a third embodiment of the present invention;

FIG. 28 is a diagram showing the structure of a network DB shown in FIG. 27;

FIG. 29 is a schematic view showing the structure of a manual providing system according to a fourth embodiment of the present invention;

FIG. 30 is a block diagram showing the structure of a terminal shown in FIG. 29;

FIG. 31 is a diagram showing the structure of a network DB shown in FIG. 29;

FIG. 32 is a diagram exemplifying data stored in a user information DB shown in FIG. 31;

FIG. 33 is a flowchart for explaining “E-Manual Output Process” according to the fourth embodiment of the present invention;

FIG. 34 is a diagram exemplifying a screen image displayed through the e-manual output process shown in FIG. 33;

FIGS. 35A and 35B are diagrams exemplifying screen images displayed through the e-manual output process shown in FIG. 33;

FIG. 36 is a schematic view showing the structure of a manual providing system according to a fifth embodiment of the present invention;

FIG. 37 is a block diagram showing the structure of a server shown in FIG. 36;

FIG. 38 is a functional block diagram for explaining functions of a control unit shown in FIG. 37;

FIG. 39 is a diagram exemplifying data stored in a manual DB of the server shown in FIG. 36;

FIG. 40 is a diagram exemplifying data stored in a user information DB of the server shown in FIG. 36; and

FIG. 41 is a flowchart for explaining “Manual Distribution Process” according to the fifth embodiment of the present invention.

### DETAILED DESCRIPTION OF THE PREFERRED EMBODIMENTS

Preferred embodiments of the present invention will now be described with reference to the accompanying drawings.

### First Embodiment

A manual providing apparatus according to a first embodiment of the present invention comprises an image forming apparatus, especially an MFP (Multi Function Printer). Typical MFP is an apparatus including multiple functions such as copier, facsimile, printer, scanner, and the like. In this embodiment, a case where an MFP is being used as office equipment will be described. An MFP 100 according to the first embodiment of the present invention has functions not only ordinal functions such as copier, facsimile, etc., but also electronic manual (hereinafter, referred to as “e-manual”) output function. In this embodiment, the MFP 100 outputs e-manuals regarding the MFP 100.

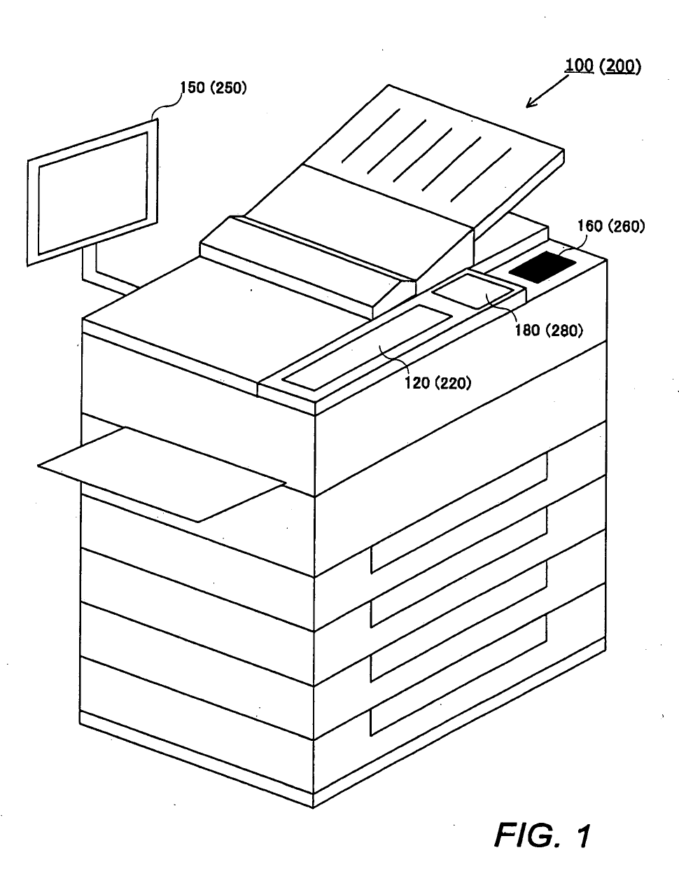

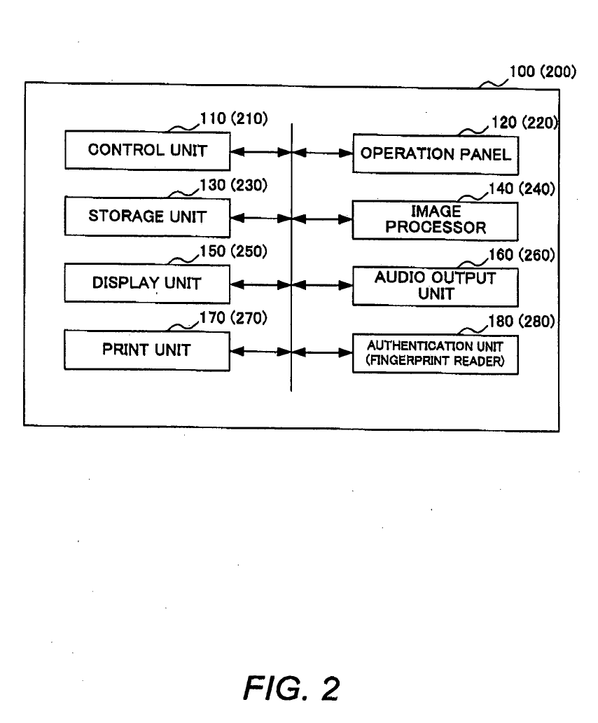

FIGS. 1 and 2 are diagrams showing the structure of the MFP 100 according to this embodiment. FIG. 1 is an exterior view showing-external structure of the MFP 100, while FIG. 2 is a block diagram showing internal structure of the MFP 100. As shown in those diagrams, the MFP 100 of the first embodiment comprises a control unit 110, an operation panel 120, a storage unit 130, an image processor 140, a display unit 150, an audio output unit 160, a print unit 170, and an authentication unit 180.

The control unit 110 may comprise a CPU (Central Processing Unit) and the like to control whole of the MFP 100. The control unit 110 executes program data in the storage unit 130, thus the process described later are realized.

The operation panel 120 may be an LCD (Liquid Crystal Display) with touch screen function (touch panel function), to be used as an interface to a user. The operation panel 120 accepts the user's operation, and inputs signals according to the operation to the control unit 110.

The storage unit may comprise a semiconductor memory (for example, ROM (Read Only Memory), RAM (Random Access Memory), flash memory, and the like), a magnetic disk storage (for example, hard disk drive, or the like), and the like to store various data and programs to be executed by the control unit 110.

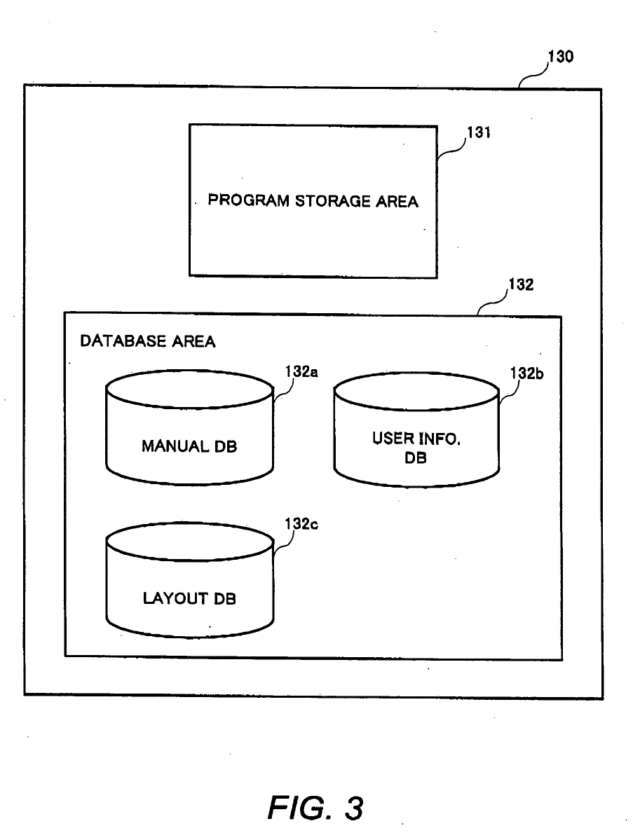

FIG. 3 shows the structure of the storage unit 130. As shown in FIG. 3, the storage unit 130 comprises a program storage area 131 for storing programs to be executed by the control unit 110, and a database (DB) area 132 for storing necessary data. In this embodiment, a manual DB 132a, a user information DB 132b, and a layout DB 132c are prepared in the DB area 132.

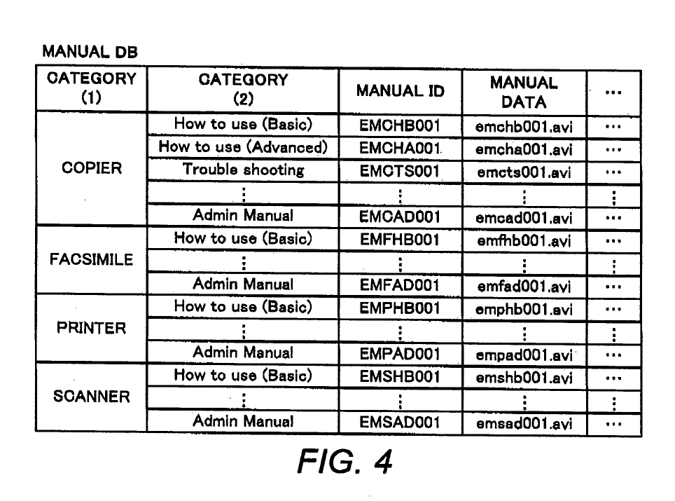

The manual DB 132a is a database for storing e-manuals to be output by the MFP 100. In this embodiment, electronic data of manuals regarding the MFP 100 are stored in the manual DB 132a. Samples of date stored in the manual DB 132a will now be described with reference to FIG. 4.

As shown in FIG. 4, the manual DB 132a includes a plurality of records each corresponds to predetermined contents of the manual being categorized. Since the manual DB 132a stores e-manuals regarding the MFP 100, the files of the e-manuals are categorized in accordance with, for example, functions of the MFP 100, search index for users, and the like. For example, if the MFP 100 has 4 functions (“copier”, “facsimile”, “printer”, and “scanner”), the e-manuals regarding the MFP 100 are categorized in accordance with those functions (shown as “Category (1)”). Thus, categorized e-manuals are further categorized by, for example, search index. Search index is prepared based on, for example, situations or purposes where a user refers to the manual. In this embodiment, the e-manuals in each of categories for Category (1) are further categorized by search index items, for example, “How to Use (Basic)”, “How to Use (Advanced)”, “Trouble Shooting”, “Admin Manual”, and the like (shown as “Category (2)”).

Unique ID (manual ID) for identifying each e-manual file is assigned to each of thus categorized e-manual files. The manual ID works as primary key of each record in the manual DB 132a.

Data of each manual (hereinafter, referred to as “manual data”) are stored in a corresponding record. In this embodiment, e-manuals include movie files to be output. Therefore, not only fundamental information showing title of the e-manual, also coded movie data are stored in the each record in the manual DB 132a. The movie data may be coded in accordance with predetermined coding format.

Details of the manual data will now be described. Since the MFP 100 according to this embodiment outputs manuals regarding the MFP 100, the e-manuals include movies showing user actions for operating the MFP 100 or for taking care of the MFP 100, and text or voice data representing guidance corresponding to the movie. Movies may be CG (Computer Graphics) animation, video images, and the like.

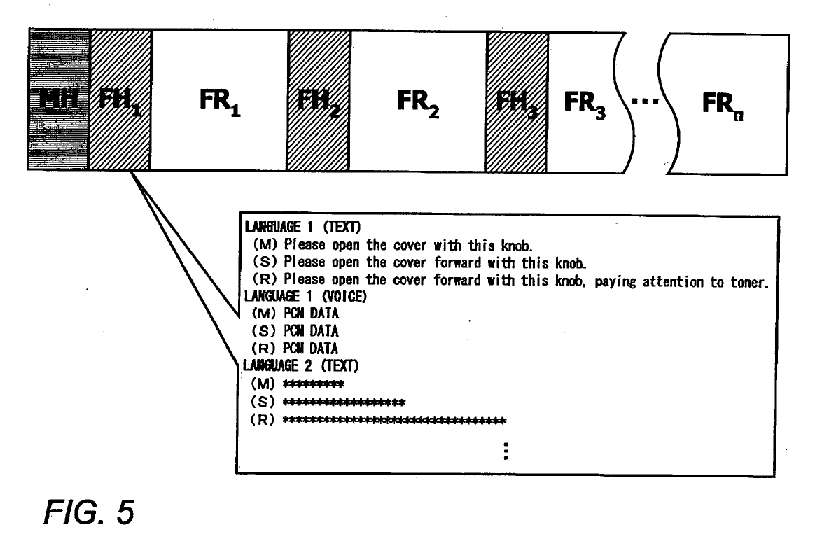

The movie data has the data structure as shown in FIG. 5. A unit of the movie file is a data stream DS comprising a plurality of image frames (FR₁ to FRₙ). Each data stream DS has its header (hereinafter, referred to as “main header MH”) including ID of the data stream DS and the like. Further, each of the frames has its header (hereinafter, referred to as “frame header FH”).

The main header MH may include information showing, for example, the manual ID assigned to the e-manual concerned.

As shown in FIG. 5, each of the frame headers FH includes text data and voice data representing guidance (hereinafter, referred to as “guidance data”) of the scene shown by the frame concerned. In this embodiment, such the guidance data may be recorded in the frame headers FH of predetermined frames showing, for example, highlight scenes in the movie.

Such the guidance data to be recorded in the frame headers FH are text data or voice data (for example, PCM (Pulse Code Modulation) format audio data) representing, for example, sentences for explaining user operation, caution, and the like to be presented at the scene concerned. The guidance data are prepared scene by scene. Further, each of the sentences of the guidance data includes a plurality of sentence length. In this embodiment, different lengths are prepared at each scene. For example, 3 different lengths “minimum (M), “short (S)”, and “regular (R)” are prepared in this embodiment. The each of the frame headers FH also includes translated guidance data corresponding to foreign languages. Accordingly, each of the frame headers FH has guidance data for 1 scene including plurality of formats, that is, multiple lengths text and voice for multiple languages.

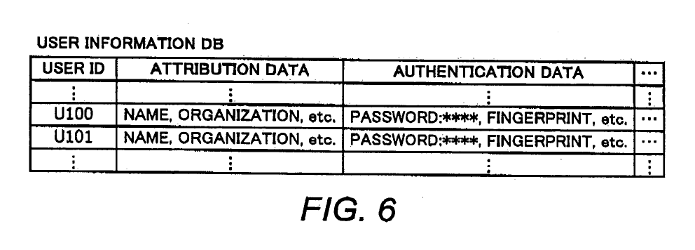

Details of the user information DB 132b will now be described. The user information DB 132b stores information regarding specific users of the MFP 100. The specific user may be, for example, an administrative user (administrator) of the MFP 100 who is able to handle important settings of the MFP 100. The administrators must be distinguished from other ordinary users, because they are allowed to handle some limited operations. If such the limited operation is required, user authentication is necessary for assuring whether the user is administrator or not. The user information DB 132b stores administrators' information necessary for such the user authentication. Data stored in the user information DB 132b will now be described with reference to FIG. 6.

As shown in FIG. 6, records each having a primary key representing user ID which is a unique ID assigned to each administrator. In each record, attribution data representing name of the administrator concerned and the like are stored. Additionally, authentication data necessary for the user authentication are also stored in each record. Format of the authentication data is arbitrary in accordance with the authentication type of the MFP 100, For example, if the MFP 100 employs fingerprint authentication, image data showing fingerprint of the administrators are stored as the authentication data.

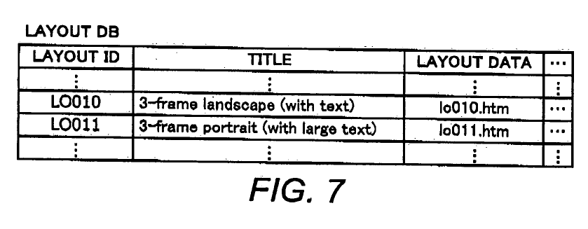

Details of the layout DB 132c will now be described. The layout DB 132c stores data for regulating print layout for printing the contents of the e-manuals. In this embodiment, the e-manuals are able to be printed out with using the image forming mechanisms of the MFP 100. The MFP 100 previously has layout data for many layouts for printing to be selectable by the user. The layout DB 132c stores layout data representing such the layout patterns for printing. Detailed data stored in the layout DB 132c will now be described with reference to FIG. 7.

As shown in FIG. 7, the layout DB 132c includes plurality of records each having layout ID as a primary key which is a unique ID for each of the layout patterns. Layout data regulating the layout pattern concerned are stored in each record together with basic information such as title of the layout pattern and the like. The layout data may be written in, for example, a predetermined markup language such as HTML (Hyper Text Markup Language).

Those are the explanations of the database, and the other components of the MFP 100 will now be described.

The image processor 140 may comprises a predetermined electronic circuit or the like for image processing. In this embodiment, the image processor 140 processes the manual data retrieved by the control unit 110 from the manual DB 132a. More precisely, the image processor 140 decodes the movie data to play with outputting the guidance data. Additionally, the image processor 140 processes the manual data to be printed. In this case, the image processor 140 performs, for example, extraction of necessary image frames from the movie frames, arrangement of the images or texts based on the layout pattern, and the like.

In this embodiment, the image processor 140 is realized by a hardware component as described above. Instead of this structure, functions of the image processor 140 may be realized by the control unit 110 with software processing. In this case, the program storage 131 stores programs for realizing the functions of the image processor 140, and the control unit 110 executes the program, thus, the control unit 140 is able to act as the image processor 140.

The display unit 150 may comprise a display device such as LCD to display information. In this embodiment, the display unit 150 mainly displays the e-manuals as movie format.

The audio output unit 160 may comprise, for example, a speaker or the like to output audio information. In this embodiment, the audio output unit 160 mainly outputs voices of the guidance data while playing the e-manual as movie.

The print unit 170 may be a typical image forming mechanism of the MFP to print out images on predetermined sheets. In this embodiment, the print unit 170 prints out the e-manual in accordance with the requested layout.

The authentication unit 180 is a predetermined device to be used for user authentication. The type of the device may be arbitrary in accordance with the authentication type. If the MFP 100 employs, for example, fingerprint authentication, the authentication unit 180 may be an image scanner to read fingerprint.

The above described components are necessary structure for realizing the electronic manual output according to the present invention. The MFP 100 tacitly comprises other components necessary for fundamental functions of the MFP (such as copier, facsimile, printer, and scanner), and detailed descriptions of those components are omitted here.

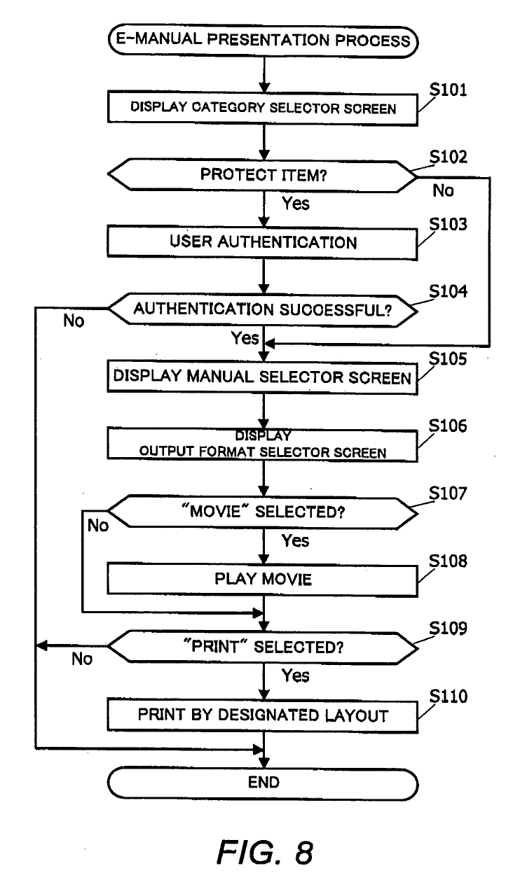

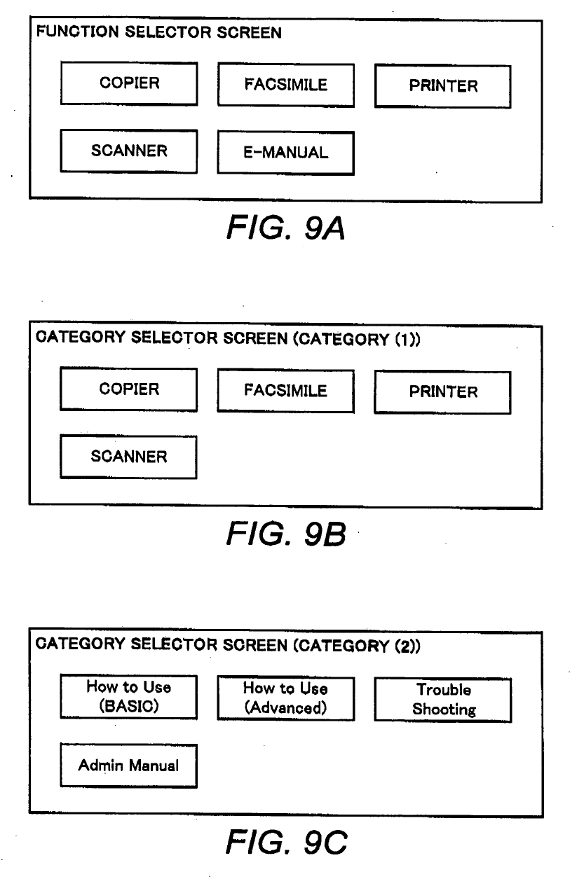

Operation of thus structured MFP 100 will now be described. In order to realize the e-manual output according to the present invention, the MFP 100 carries out “E-Manual Presentation Process”. The operations through the e-manual presentation process will now be described with reference to FIG. 8. FIG. 8 is a flowchart for explaining the process. This process may start in response to the user's instruction with selecting e-manual function. More precisely, the operation panel 120 constantly displays a function selector screen as shown in FIG. 9A while the MFP 100 is being activated. The user selects desired function through the function selector screen. The function selector screen includes not only buttons for selecting fundamental functions of the MFP 100 (that is, copier, facsimile, printer, and scanner, for example), also an “e-manual” button for selecting the e-manual output function. When the user requires e-manual for reference, the user selects the “e-manual” button on the operation panel 120. This action causes the MFP 100 to start the e-manual presentation process, that is, the control unit 110 starts to execute programs necessary for realizing this process.

Once the process starts, the control unit 110 displays a category selector screen on the operation panel 120 for specifying the e-manual desired by the user (step S101).

In this case, the control unit 110 accesses the manual DB 132a, and displays items of Category (1) as selectable buttons on the operation panel 120 (see FIG. 9B). If the user wants to see, for example, a manual regarding the copier function of the MFP 100, the user selects “copy” button in the function selector screen on the operation panel 120, After desired category in Category (1) is selected as such the manner, the control unit 110 specifies sub items in Category (2) corresponding to the selected category of Category (1), and displays the specified items as selectable buttons on the operation panel 120 (see FIG. 9C). The user selects desired items of Category (2) in accordance with the user's demands or the like.

After the user selects a desired item of Category (2), the control unit 110 determines whether the selected item is a predetermined protect item or not (step S102). “Protect item” means items being limited to specific users such as the administrator. In this embodiment, the control unit 110 determines that the protect item is selected if “Admin Manual” is selected. “Admin Manual” means special manual limited to the administrator, and one of the items in Category (2).

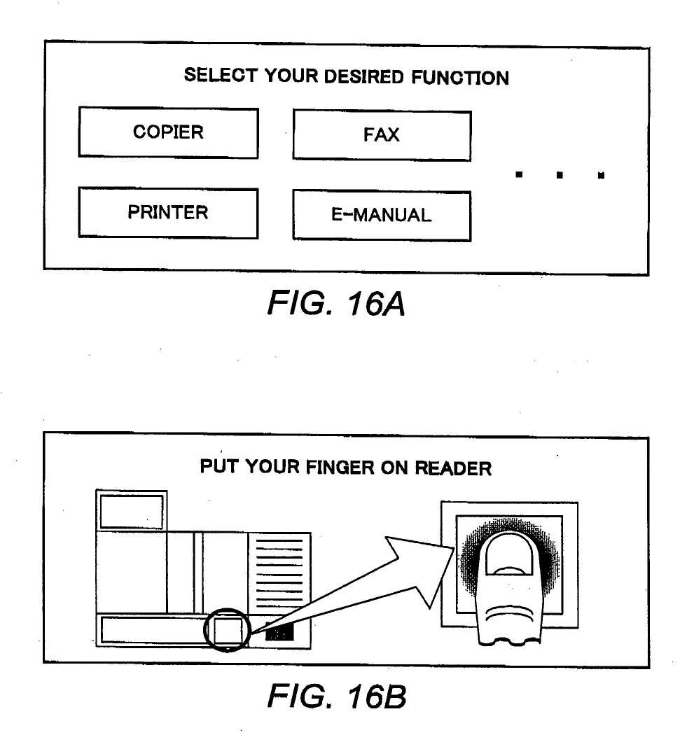

In a case where the protect item is selected (step S102: Yes), the control unit 110 collaborates with the authentication unit 180 to perform user authentication (step S103). In this case, the control unit 110 requests the user to provide necessary authentication data with predetermined notification. If the MFP 100 employs fingerprint authentication, the control unit 110 displays predetermined notice screen (see FIG. 16B) for requesting the user to enter the fingerprint. As the user puts the finger on the authentication unit 180, the control unit 110 reads the fingerprint image of the user. Then, the control unit 110 accesses the user information DB 132b to determine whether the same fingerprint image has been registered or not.

If the user authentication is successful (step S104: Yes), or, an item other than the protect items is selected (step S102: No), the control unit 110 obtains titles of the manuals corresponding to the selected item of Category (2), and displays those titles as selectable buttons or the like on the operation panel 120 (step S105).

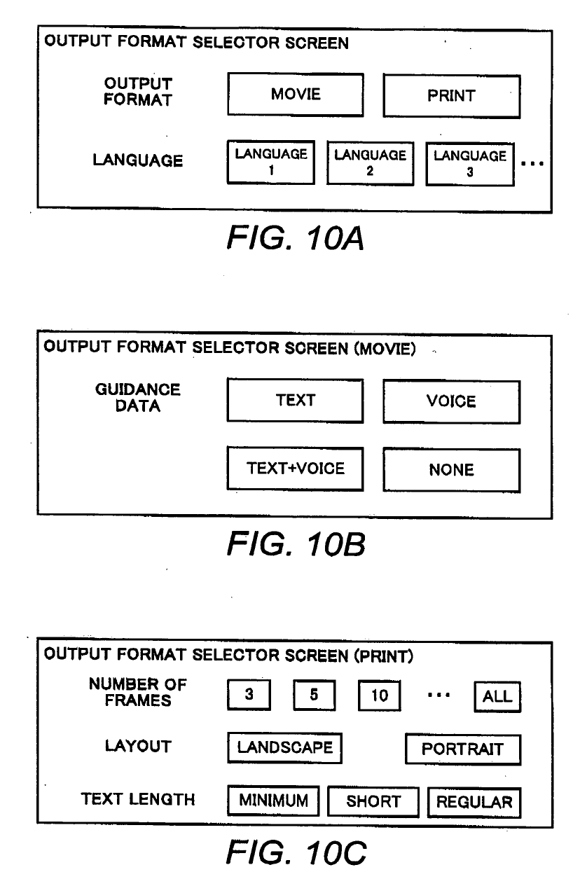

The user selects desired manual by selecting a corresponding title from the displayed titles. As one of the titles is selected, the control unit 110 obtains manual data (movie data) corresponding to the selected title from the manual DB 132a, and displays output format selector screen (see FIG. 10A) on the operation panel 120 in order to lead the user to select desired output format (step S106).

As shown in FIG. 10A, the output selector screen includes selectable buttons (style selector buttons) for selecting output style, movie play or print. The output format selector screen also has other selectable buttons (language selector buttons) for selecting language of the guidance data.

The output format selector screen has a plurality of screen images corresponding to the user's selection. For example, when “Play Movie” is selected as output style, the additional screen as shown in FIG. 10B is displayed (shown as “Output Format Selector Screen (Movie)”. In this case, selectable buttons for selecting preference of guidance data to be output with playing the movie are displayed.

Or, when “Print” is selected as output style, the additional screen as shown in FIG. 10C is displayed (shown as “Output Format Selector Screen (Print)”). In this case, selectable buttons for, for example, designating the number of frames to be extracted for printing, layout of the frames, length of the guidance data, and the like are displayed.

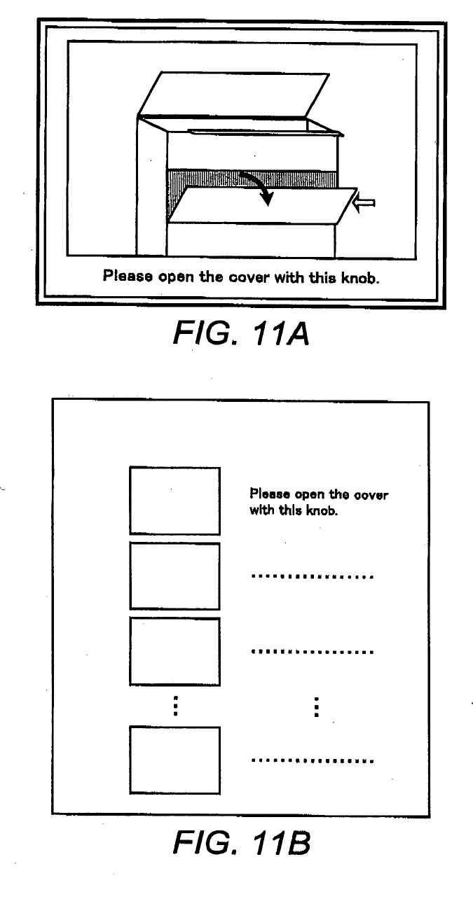

The user selects desired output style and language by selecting corresponding buttons on the operation panel 120. If “Play Movie” is selected as desired output style (step S107: Yes), the control unit 110 transfers the obtained movie file to the image processor 140. The image processor 140 decodes the transferred movie data to play (step S108). More precisely, the image processor 140 outputs the decoded movie data to the display unit 150 and the audio output unit 160, thus the e-manual is played as movie as shown in FIG. 11A.

As for the data decoding, the image processor 140 decodes the movie data frame by frame. If the image processor 140 finds guidance data in the frame header FH of the decoded frame, the image processor 140 obtains user instruction information representing desired output format (that is, for example, “no guidance”, “text only”, “voice only”, “text with voice”, or the like). The image processor 140 obtains guidance data corresponding to the user's preference from the frame header FH, and outputs the guidance data to the display unit 150 and/or the audio output unit 160. Thus, the guidance data corresponding to language and output style designated by the user are output with playing movie image.

Accordingly, the user is able to refer the desired manual as movie while operating the MFP 100. In a case where, for example, a user does not know how to use the MFP 100, the user is able to learn how to use it easily with actually operating the MFP 100 in accordance with the guidance being output as movie.

A case where a user faces troubles on the MFP 100 is another situation where the user needs the manual. Some trouble cases require the user to turn off the MFP 100 to recover from the trouble. In such the cases, the user is not able to work for recovering with referring the movie manual. However, the user is able to avoid such the inconveniences by previously printing the necessary e-manual before turn off the MFP 100.

To print out the e-manuals, the user selects “Print” button through the output format selector screen shown in FIG. 10A. If “print” is selected as output format (step S109: Yes), the control unit 110 displays the additional screen as shown in FIG. 10C on the operation panel 120.

The user designates desired layout pattern by selecting a corresponding button. Once the layout is designated, the control unit 110 obtains corresponding layout data from the layout DB 132c, and transfers the layout data to the image processor 140 together with the manual data.

The image processor 140 extracts necessary frames and corresponding guidance data from the manual data in accordance with the output format designated by the user, and arranges the extracted frame images and guidance data (text) based on the layout data, thus generates print image data.

The image processor 140 transfers the print image data to the print unit 170. The print unit 170 prints out the images represented by the print image data. Thus, the manual is printed out in accordance with the user's demands as shown in FIG. 111B (step S110), and the process is terminated.

According to the manual providing apparatus (MFP 100) of this embodiment, movie base electronic manuals are output corresponding to users' demands (format, style, layout, and the like) as described above. Those are helpful and user friendly function for users of the MFP.

In the above embodiment, though the guidance data are included in the frame headers each for each of the frames of a movie stream, record format for the guidance data is not limited to that, and arbitrary record formats may be applicable. For example, if the MFP 100 comprises an extra database for storing guidance data, data representing the guidance data in the manual data may be simplified as code data. More precisely, the database may stores the guidance data to each of which a unique code is assigned. In this case, such the simple code data may be recorded in each of the frame headers. This structure may be helpful for reducing the data size of the manual data even if the manual includes a large amount of guidance data.

As for the voice data, those may be recorded in predetermined audio track area instead of the frame headers of movie image data.

In the above embodiment, multiple guidance data units corresponding to various languages are prepared. Instead of such the structure, for example, the control unit 110 or the image processor 140 may have translation function, In this case, the guidance data are translated by the translation function when foreign language is designated by the user. This structure is helpful for reducing data size of the manual data.

### Second Embodiment

The above first embodiment exemplifies a case where the MFP outputs e-manuals regarding the MFP concerned in the office or the like. A manual providing apparatus according to the present invention may output various kinds of manuals. Instead of the office use described in the first embodiment, the MFP may be used at various common places such as shops and the like. Such the common use MFP may provide various kinds of manuals as service. This embodiment will describe another manual providing apparatus which is able to provide various kinds of manuals.

The manual providing apparatus according to this embodiment is also realized by an MFP whose structure is basically the same as that of the MFP 100 according to the first embodiment. As well as the first embodiment, FIGS. 1 and 2 also show the external and internal structures of an MFP 200 according to the second embodiment. That is, as shown in those diagrams, the MFP 200 comprises a control unit 210, an operation panel 220, a storage unit 230, an image processor 240, a display unit 250, an audio output unit 260, a print unit 270, and a fingerprint reader 280. In this embodiment, the MFP 200 may be settled at a convenience store to provide services according to fundamental functions of the MFP such as copier and facsimile. In addition to providing such the fundamental services, the MFP 200 provides various manuals regarding, for example, sports, cooking, and the like. Details of the structure of the MFP 200 will now be described.

The structures and functions of the control unit 210, the operation panel 220, the storage unit 230, the image processor 240, the display unit 250, the audio output unit 260, the print unit 270, and the fingerprint reader 280 are basically the same as those of the control unit 110, the operation panel 120, the storage unit 130, the image processor 140, the display unit 150, the audio output unit 160, the print unit 170, and the authentication unit 180 described in the first embodiment respectively.

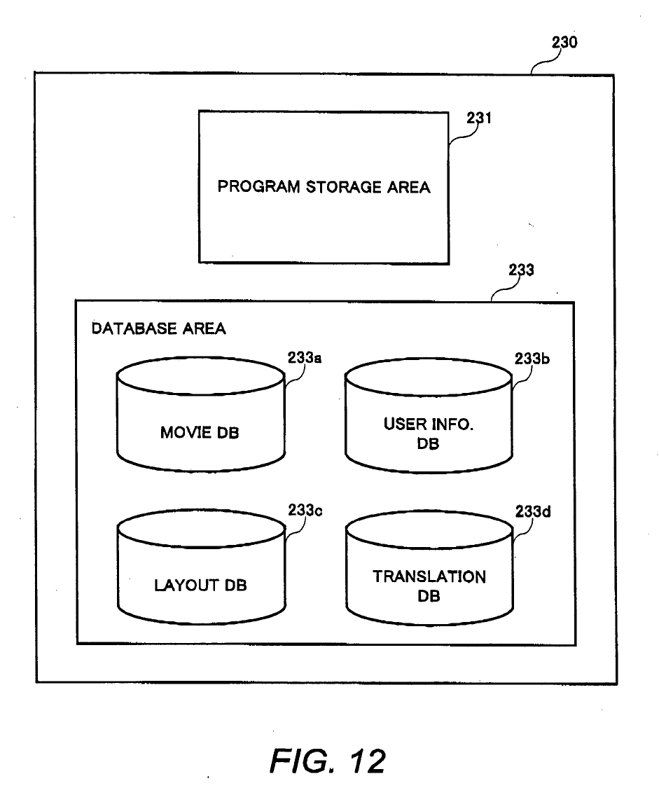

However, database structure in the storage unit 230 may differ from that in the storage unit 130. The database structure according to this embodiment will now be described with reference to FIG. 12.

As shown in FIG. 12, the storage unit 230 comprises a program storage area 231 for storing program data to be executed by the control unit 210 and a database (DB) area 232 for storing data necessary for realizing the manual providing. In this embodiment, a movie file DB 232a, a user information DB 232b, a layout DB 232c, and a translation DB 232d are prepared in the DB area 232.

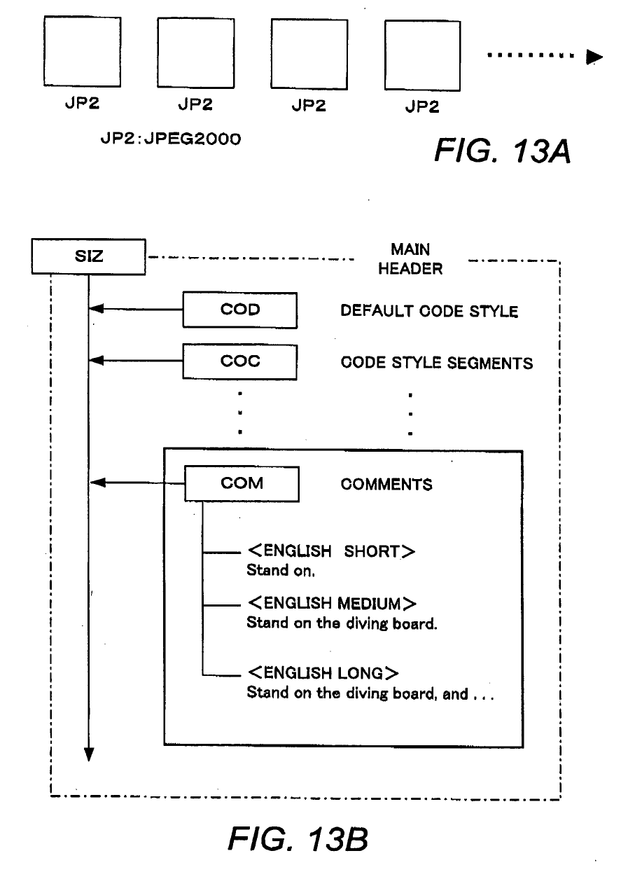

The movie file DB 232a is a database for storing data representing various manuals to be output by the MFP 200. The data in the movie file DB 232a are stored as movie data format (hereinafter, referred to as “movie manual”). Each of the movie manuals is stored as, for example, “Motion-JPEG2000” format. According to Motion-JPEG2000, each of frame images in a movie is coded individually by Motion-JPEG2000 format. Those frame images are compressed by predetermined data compression format, while being associated with actions respectively. Some of the frame images have guidance text for explaining specified scenes. More precisely, the movie manual data have “COM marker” for storing the guidance text in a main header as shown in FIG. 13B. In the COM marker, guidance texts written in a predetermined language (for example, Japanese) corresponding to the frame concerned are recorded. The guide texts have variations of different lengths. Audio data representing voice guidance in the predetermined language (for example, Japanese) are also recording in the COM marker with being associated with each of the guidance texts.

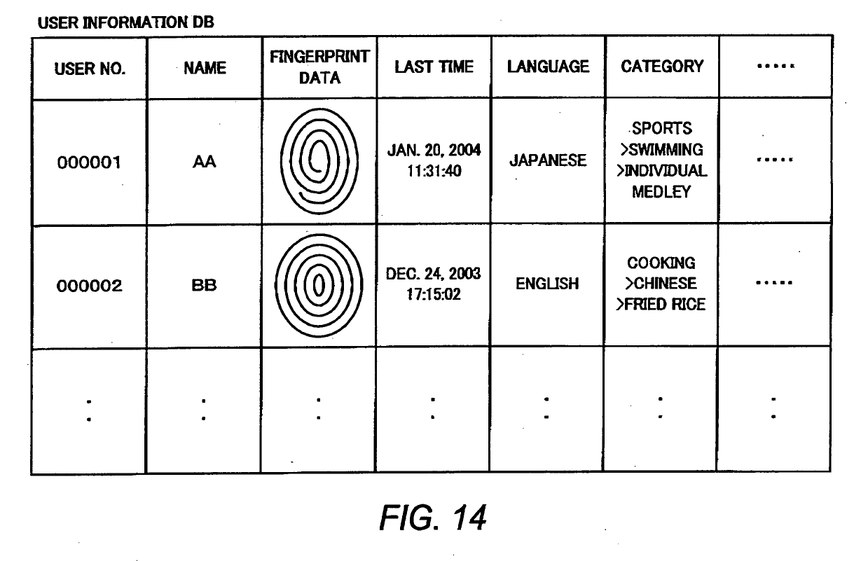

The user information DB 232b is a database for storing user information for specifying persons (users) who are able to use the MFP 200. In the user information DB 232b, a table as shown in FIG. 14 is prepared. The table includes, for example, user name and fingerprint data being associated with each other. The user information DB 232b also stores other data such as information representing date when the user uses the manual providing system last time, and configuration data (information representing type of the manual, language, and the like when the user used last time).

The layout DB 233c is a database for storing information regarding layout of a manual to be presented to a user eventually. The layout DB 232c stores a plurality of sets of layout data in accordance with frame images of the manual and lengths of the guidance texts corresponding to the frame images. The layout data may be regulated by a language, for example, HTML.

The translation DB 232d is a database for storing sentences written in a plurality of languages representing the guidance texts in each manual. In the translation DB 232d, the guidance text of the manual in the predetermined language (Japanese) and translated texts representing contents of the guidance text in other languages are associated with each other.

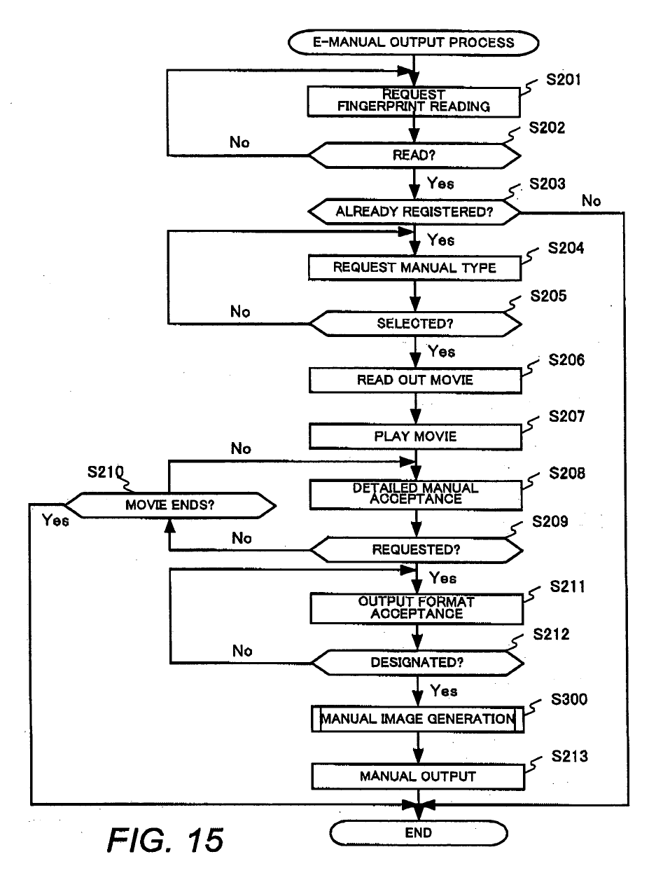

“Manual Output Process” according to this embodiment will now be described with reference to a flowchart shown in FIG. 15. In this embodiment, operations for outputting a manual regarding, for example, individual medley swimming with using the MFP 200 settled in, for example, a convenience store. In this embodiment, only predetermined users may be allowed to use the MFP 200 to output manuals, and the user information DB 232b previously stores information about those allowed users.

Once the MFP 200 is turned on by a user, the control unit 210 controls the operation panel 220 to display a menu selector screen as shown in FIG. 16A. The user presses the panel in accordance with the display on the panel to input. Operations after “e-manual” is selected by the user through the menu screen will now be described with reference to the flowchart shown in FIG. 15.

First of all, the control unit 210 controls the operation panel 220 having touch screen structure to display a screen image as shown in FIG. 16B, in order to cause the user to put the user's finger on a predetermined point, thus requesting the fingerprint reader 280 to read the fingerprint (step S201). The fingerprint reader 280 obtains finger print image, and supplies the image data to the control unit 210.

The control unit 210 determines whether the fingerprint has been read and the image data representing the fingerprint have been supplied or not (step S202). If it is determined that the fingerprint image data have not been supplied (step S202: No), the process flow goes back to step S201, thus the control unit 210 controls the operation panel 220 to continuously display the screen for requesting the fingerprint reading.

On the other hand, if it is determined that the fingerprint image has been supplied (step S202: Yes), the control unit 210 accesses the user information DB 232b in the storage unit 230 to determine whether the fingerprint image supplied from the fingerprint reader 280 coincides with one of the fingerprint images stored in the user information DB 232b (that is, fingerprint image registered as a user) or not (step S203). If it is determined that the read fingerprint image is not registered one (step S203: No), the control unit 210 terminates the process.

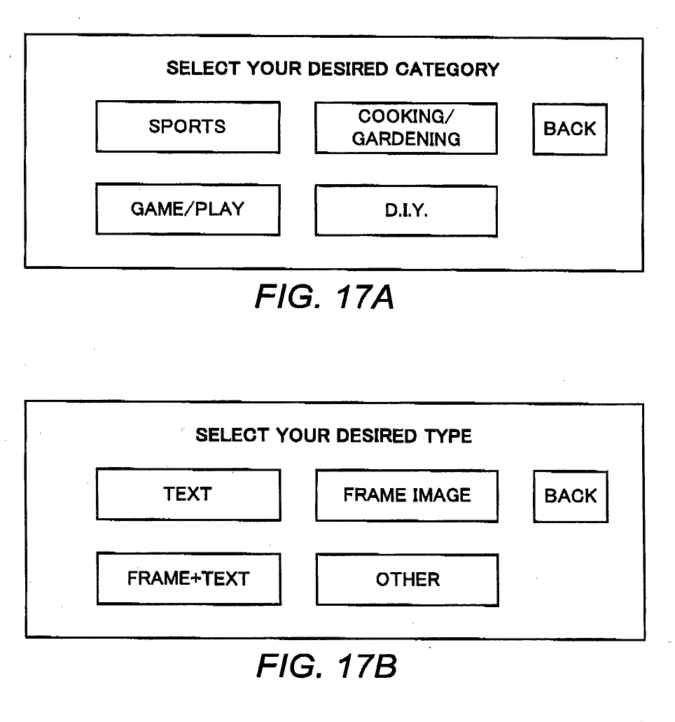

If it is determined that the read fingerprint is registered one (step S203: Yes), the control unit 210 controls the operation panel 220 to display a predetermined screen for selecting a type of the manuals, thus the user is requested to select desired type of the manuals (step S204). More precisely, the control unit 210 displays a category selector screen as shown in FIG. 17A to request the user to select desired category. Then, the operation panel 220 displays another screen (not shown) for requesting the user to select more detailed titles of the manual. The user operates the operation panel 220 in accordance with the screen display to select desired category of the manual. In this embodiment, the user may select “sports” category, and select “individual medley swimming” as a detailed title.

The control unit 210 determines whether it receives a predetermined signal representing that title of the manual has been selected from the operation panel 220 or not (step S205). If it is determined that the title of the manual is not selected (step S205: No), the process flow goes back to step S204, that is, the control unit 210 continues to request the user to select the type and title of desired manual.

If it is determined that the title of the desired manual is selected (step S205: Yes), the control unit 210 accesses the movie file DB 232a in the storage unit 230 to read a movie file corresponding to the title received at step S205 from the stored movie files (step S206).

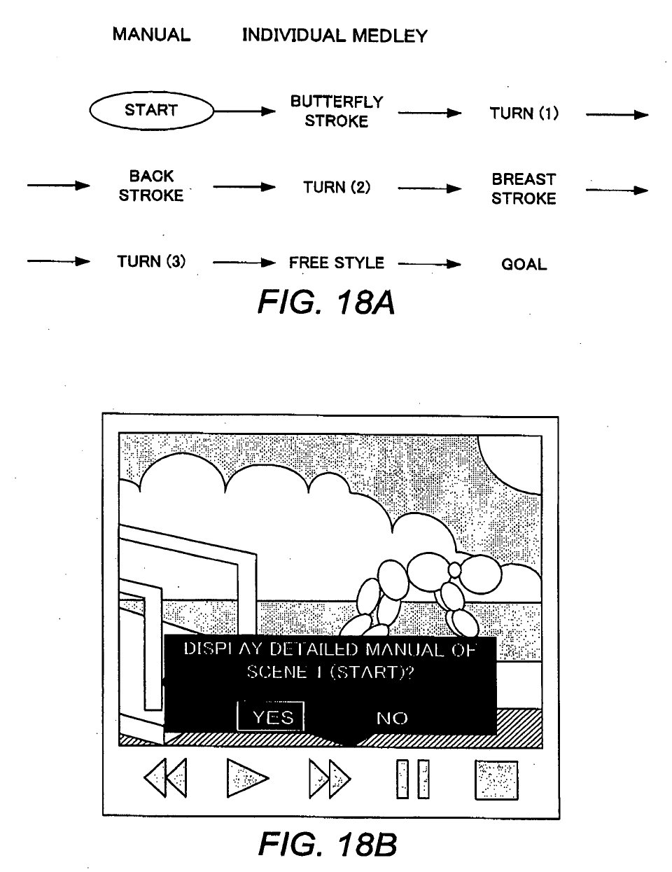

The control unit 210 loads predetermined program from the storage unit 230 to play the movie (step S207), thus the movie is displayed on the display unit 250. As aforementioned, since “individual medley swimming” was selected at steps S204-S205, movie regarding individual medley swimming is played and displayed. For example, individual medley swimming includes 9 steps “start”, “butterfly stroke”, “turn (1)”, “backstroke”, “turn (2)”, “breast stroke”, “turn (3)”, “freestyle”, and “goal” as shown in FIG. 18A.

The control unit 210 accepts a request for outputting detailed guidance (hereinafter, referred to as “detailed manual”) at displayed scenes while playing the movie (step S208). More precisely, for example, when a predetermined key operation is done by the user during the movie play, the control unit 210 displays a message as shown in FIG. 118B on the display unit 250 in order to ask the user to determine whether the detailed manual is required or not.

The control unit 210 determines whether “YES” on the screen shown in FIG. 18B is selected or not, that is, whether the control unit 210 receives a signal for requesting output of the detailed manual or not (step S209). If it is determined that it is not requested (step S209: No), the control unit 210 determines whether the movie play ends or not (step S210). If it is determined that the movie play does not end (step S210: No), the process flow goes back to step S208, thus, the control unit 210 continues to accept the request for outputting the detailed manual. If it is determined that the movie play ends (step S210: Yes), the control unit 210 terminates the process.

If it is determined that output of the detailed manual is requested (step S209: Yes), the control unit 210 controls the operation panel 220 to display a predetermined screen for causing the user to select output format of the manual. That is, the control unit 210 accepts user setting regarding the output format of the manual (step S211). More precisely, a selector screen as shown in FIG. 17B regarding manual type is displayed first, to request the user to select manual type, for example, frame image only, frame image+text, text only, or the like.

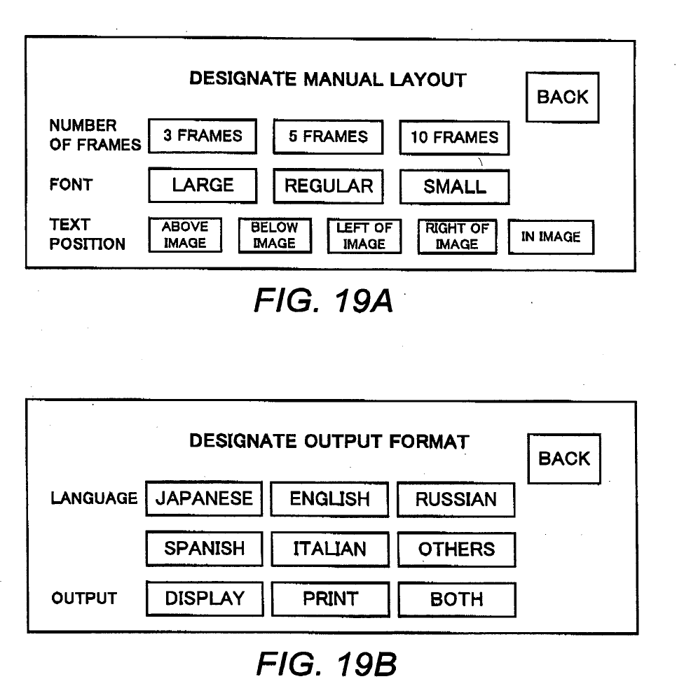

Then, another selector screen as shown in FIG. 19A is displayed, in order to request the user to set the number of frames, font, text layout (text position), and the like. Further, a screen as shown in FIG. 19B is displayed, in order to request the user to select language of the text, output format of the manual, and the like. The user operates the operation panel 220 in accordance with the displayed screen to select items, thus output format of the manual is set.

The control unit 210 determines whether the setting regarding the output format of the manual has been completed or not, that is, whether all of the setting data have arrived from the operation panel 220 or not (step S212). If it is determined that setting data have not arrived (step S212: No), the process flow goes back to step S211, thus the control unit 210 continues to request the user to set the output format.

If it is determined that reception of the setting data is completed (step S212: Yes), the control unit 210 carries out another process for generating manual images (step S300) based on the setting data and the information regarding the manual type. Details of the manual image generating process will be described later.

The control unit 210 selectively controls the display unit 250, the audio output unit 260, or the print unit 270 based on the setting data received at step S212 to output the generated manual images (step S213).

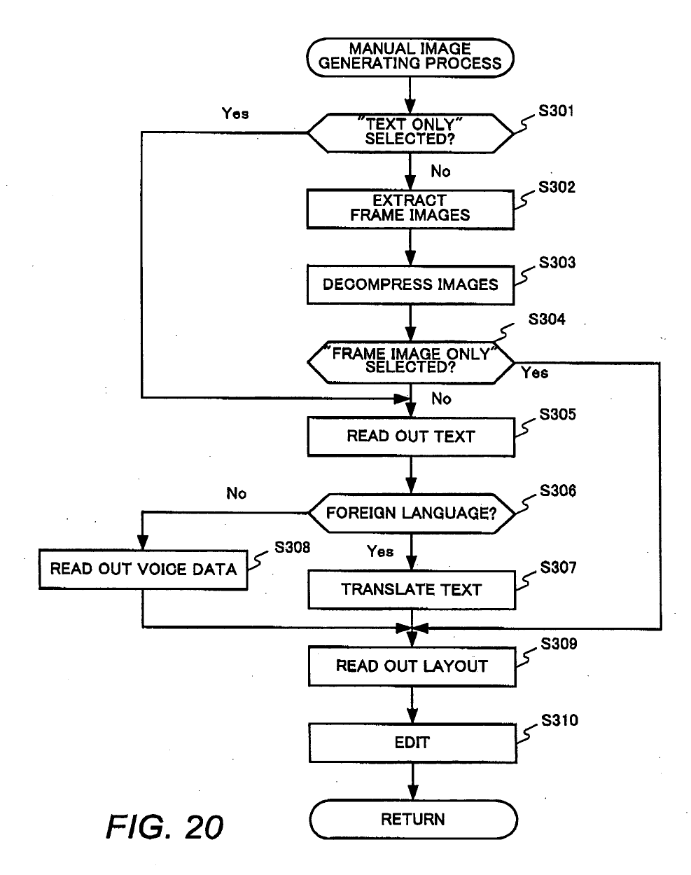

According to the above-described operations, the electronic manual output process has been done. Details of the “Manual Image Generating Process” (step S300) will now be described with reference to a flowchart shown in FIG. 20.

First of all, the control unit 210 determines whether “text” (text only) is selected based on the setting data regarding the output format received at step S212 in the aforementioned manual output process (step S301).

If it is determined that “text only” is selected (step S301: Yes), the process flow goes forward to step S305, thus the control unit 210 carries out the following steps. If it is determined that output format other than “text only” is selected (step S301: No), the control unit 210 refers to the movie file read out at step S206 of the aforementioned manual output process. The control unit 210 searches for compressed still images (frame images) having guidance text in their COM marker from the movie file, and extracts found frames (step S302).

The control unit 210 supplies the extracted compressed images to the image processor 204, and instructs the image processor 204 to decode (decompress) the images. In accordance with the instruction given by the control unit 210, the image processor 204 decompresses the compressed images (step S303).

Then, the control unit 210 determines whether “frame image only” was selected through the manual format setting (step S304). If it is determined that “frame image only” was selected (step S304: Yes), the process flow goes forward to step S309, and the control unit 220 performs the following operations.

If it is determined that another format other than “frame image only” was selected (step S304: No), the control unit 210 extracts the guidance text from COM markers corresponding to the images decompressed at step S303 (step S305). The control unit 210 further determines whether foreign language was selected or not based on the setting data received at step S211 in the aforementioned manual output process (step S306).

If it is determined that foreign language has been selected (step S306: Yes), the control unit 210 accesses the translation DB 232d to read out translation text corresponding to the guidance text extracted at step S305 (step S307). If it is determined that foreign language has not been selected (step S306: No), the control unit 210 extracts voice data corresponding to the text extracted at step S305 from COM markers corresponding to the decompressed images (step S308).

Then, the control unit 210 reads out predetermined layout data from the layout DB 232c in the storage unit 230 (step S309). The control unit 210 carries out editing in accordance with the layout with using the frame images, guidance texts, and the like.

According to the above-described operations, process for generating the manual images is done. Accordingly, it is able to selectively provide various electronic manuals in accordance with the users' demands such as movie or still images, native language or foreign language, and the like.

Since the manuals including still images with guidance texts are also available, variations for enabling more detailed explanation rather than movie manual are applied to the electronic manuals. Moreover, it is able to arrange such the user in accordance with arbitrary layout designated by the user.

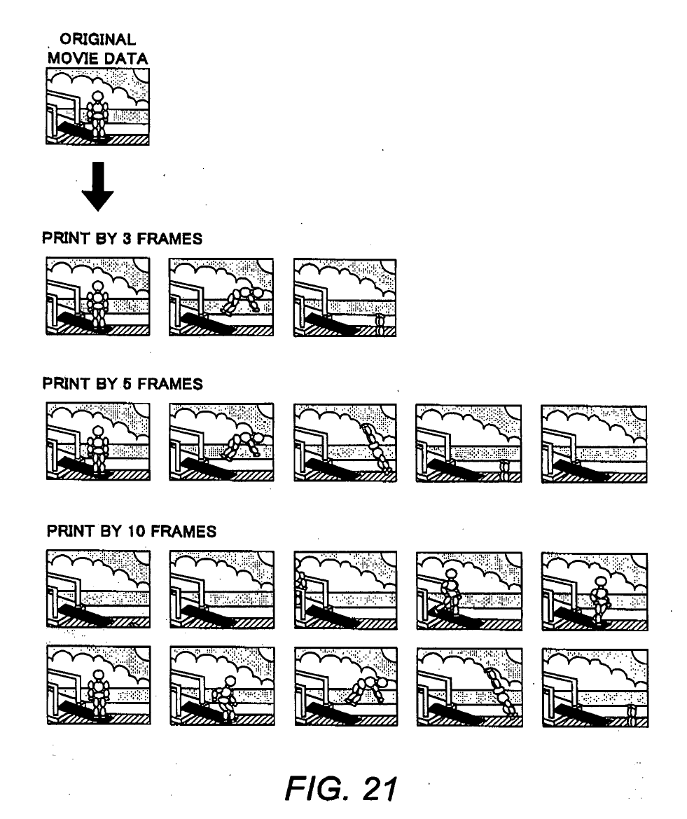

For example, if “still image” is selected through the screen shown in FIG. 17B and the number of frames (for example, 3 frames, 5 frames, 10 frames, and the like) is designated through the screen shown in FIG. 19A through steps S211-S212 of the aforementioned manual output process, a manual as shown in FIG. 21 is generated in accordance with the designated number of frames.

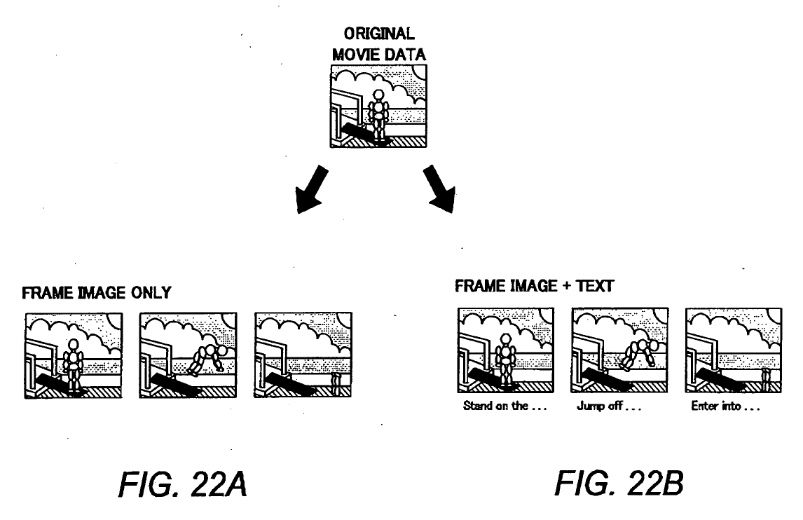

In the same manner, if “still image+text” is selected through the screen shown in FIG. 17B through steps S211-S212, a manual including the still images with texts as shown in FIG. 22B instead of still image only manual as shown in FIG. 22A.

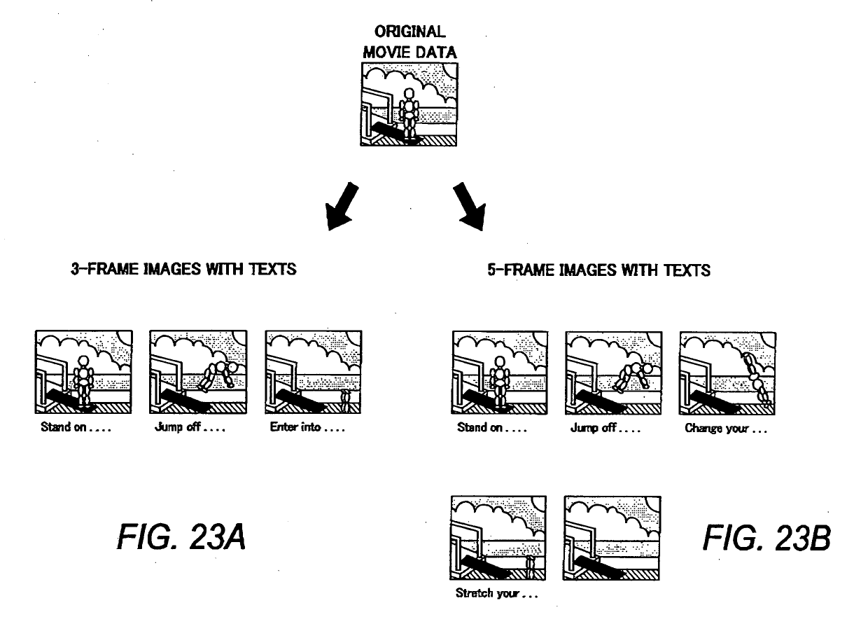

Even if “still image+text” is selected, different layout manuals are generated in accordance with the number of frames as shown in FIGS. 23A and 23B. Additionally, if the layout is arranged by edit at step S310 of the aforementioned manual image generating process, text lengths are differed from each other in accordance with the number of frames as shown in FIGS. 23A and 23B.

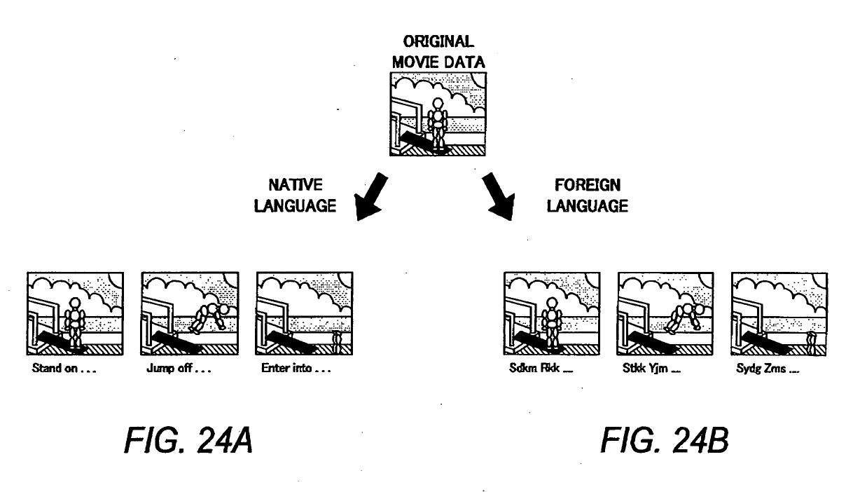

Further, if “native language” is selected through the screen shown in FIG. 19B for language selection, a manual written in the native language (for example, English) is generated as shown in FIG. 24A. On the contrary, if “foreign language” is selected, a manual including translated texts corresponding to the designated foreign language is generated as shown in FIG. 24B.

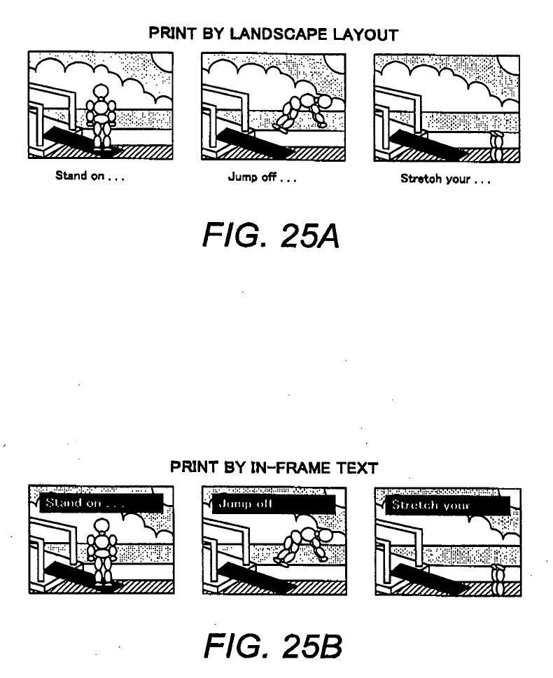

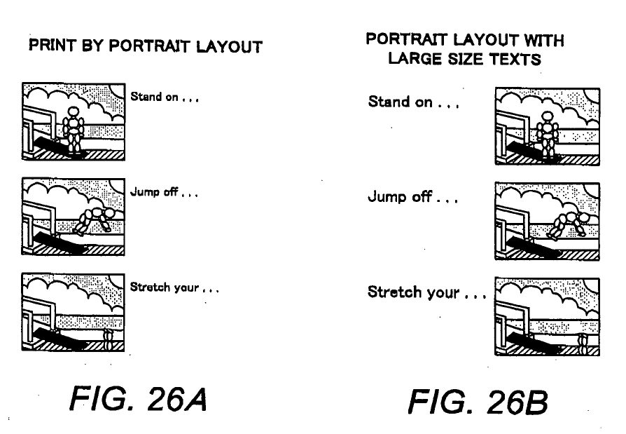

In the same manner, if text position is designated through the screen shown in FIG. 19A, manuals in accordance with the various layout patterns corresponding to the designation are generated as shown in FIGS. 25 and 26.

Those layout patterns are applicable to every embodiment in this specification. Described layout patterns are examples, and various layout patterns other than them are also applicable.

### Third Embodiment

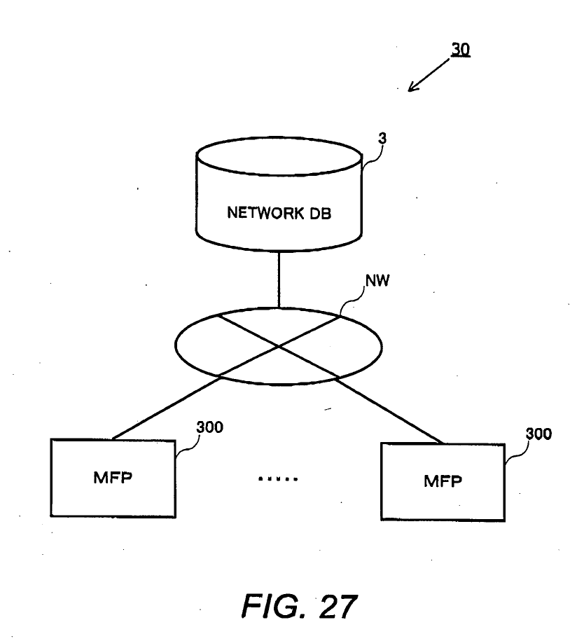

The above embodiments have described the cases where the MFP includes database regarding the manuals. Instead of such the structure, the MFP may obtain manual data from an external database via a network such as the Internet. The present embodiment will describe a manual providing system 30 comprising an MFP 300 and a network DB 3 being connected to each other via a network NW as shown in FIG. 27. The structure of the MFP 300 according to the third embodiment is similar to that of the MFP 100 or the MFP 200 described above, however, databases may be eliminated from the MFP 300.

The network NW may be PSTN (Public Switched Telephone Networks), the Internet, or the like. The MFP 300 according to the present embodiment comprises a predetermined telecommunications unit (for example, NIC (Network Interface Card), modem, and the like) being compatible with the network NW in order to connect the MFP 300 to the network NW.

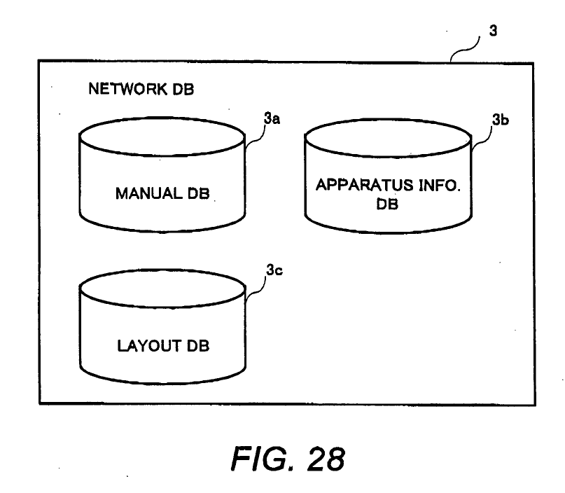

The network DB comprises a manual DB 3a, an apparatus information DB 3b, and a layout DB 3c as shown in FIG. 28.

Structures of the manual DB 3a and the layout DB 3c are the same as those of the manual DB 132a and the layout DB 132c described in the first embodiment respectively, therefore, detailed descriptions of the manual DB 3a and the layout DB 3c are omitted here.

The apparatus information DB 3b stores information regarding MFP 300 connected to the network DB 3. A unique ID (apparatus ID) is previously assigned to each of the MFP 300 connected to the network DB 3 in order to obtain the manual data. In the apparatus information DB 3b, records corresponding to apparatus ID as primary key are prepared. Each record stores information representing type or name of the MFP 300 concerned, settled place, user, and the like.

In the manual DB 3a, apparatus ID stored in the apparatus information DB 3b and manual data regarding the MFP 300 represented by the apparatus ID concerned are associated with each other.

Thus structured network DB 3 may be handled by, for example, a manufacturer of the MFP 300, or the like.

In a phase where the MFP 300 outputs manuals in the same manner as the aforementioned embodiments, the MFP 300 accesses the network DB 3 via the network NW to obtain a movie file or the like corresponding to the demanded manual from the manual DB 3a, and outputs the manual in accordance with the user's demand. In this case, the MFP 300 obtains manual data corresponding to its own apparatus ID from the Manual DB 3a.

According to this structure, it is able to realize the electronic manual providing without any data restrictions even if the MFP 300 has poor storage. Moreover, since the data are centralized, it is able to realize quick and flexible modification of the manuals or layout patterns. For example, even if the manuals are revised or updated, or additional layout patterns are created, the MFP 300 can provide the latest manuals immediately.

### Fourth Embodiment

The above embodiments have described the cases realizing the electronic manual providing with using the MFP. Instead of those structures, the electronic manuals may be provided by terminal devices such as a personal computer. The present embodiment will describe a case where a terminal device is used as the manual providing apparatus according to the present invention. This embodiment shows a manual providing system including a network DB and terminals being connected with each other. That is, this structure is similar to the manual providing system 30 in which the MFPs are replaced with the terminals.

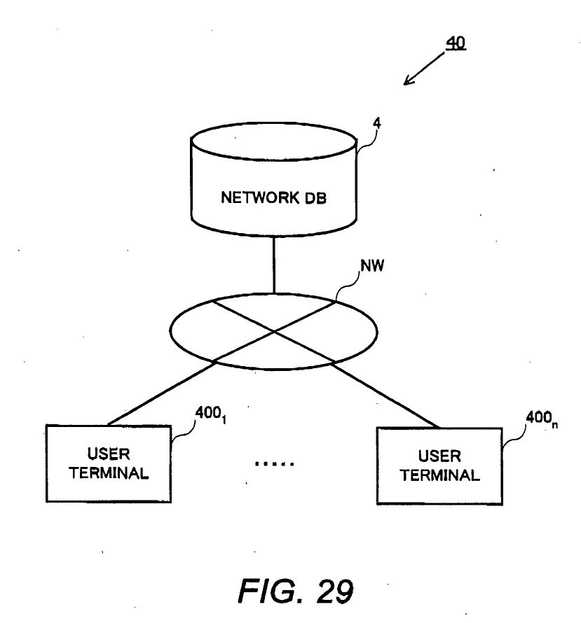

A manual providing system 40 according to the present embodiment comprises a network DB 4 and user terminals 400 (400₁ to 400ₙ) being connected to each other via the network NW as shown in FIG. 29.

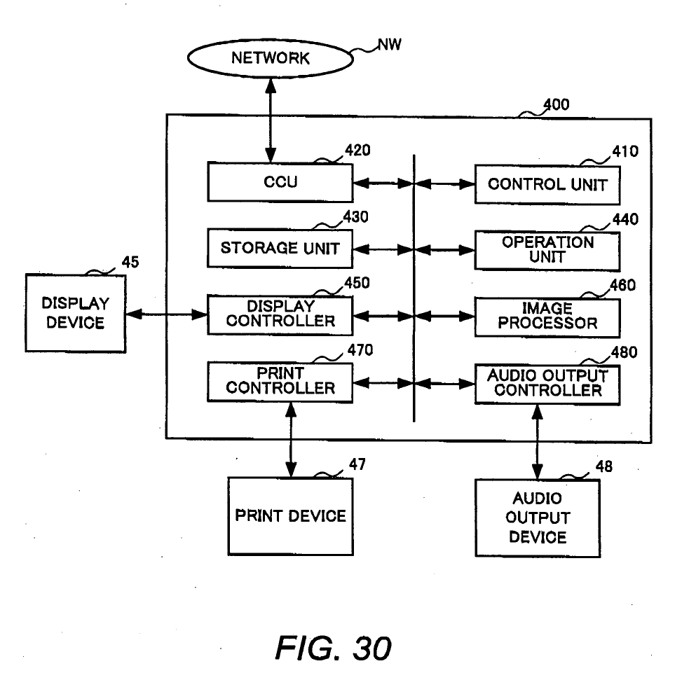

Each of the user terminals 400 comprises, for example, a general computer device such as a personal computer. As shown in FIG. 30, the user terminal 400 comprises a control unit 410, a communications control unit (CCU) 420, a storage unit 430, an operation unit 440, a display controller 450, an image processor 460, a print controller 470, and an audio output controller 480. Peripheral devices such as a display device 45, a print device 47, and an audio output device 48 are connected to the user terminal 400.

The control unit 410 comprises, for example, a CPU and the like, to controls whole of the user terminal 400. The control unit 410 executes programs stored in the storage unit 430 to realize the following processes.

The CCU 420 comprises predetermined telecommunications devices, for example, a NIC, a modem, a terminal adaptor, a router, and the like to connect the user terminal 400 to the network NW with controlling data communications via the network NW. In this embodiment, the CCU 420 mainly controls data communications between the user terminal 400 and the network DB 4 via the network NW.

The storage unit 430 may be predetermined storage devices, for example, semiconductor memories, magnetic disk storage devices, and the like. The storage unit 430 stores data necessary for realizing the manual providing and programs to be executed by the control unit 410.

The operation unit 440 comprises predetermined input devices, for example, a keyboard, pointing devices, and the like. The operation unit 440 accepts the user's operation and input signals corresponding to the user's operation to the control unit 410.

The display controller 450 interconnects the display device 45 and the user terminal 400, and controls the display device 45. According to the display controller 450, predetermined images corresponding to signals output from the control unit 410 are displayed on the display device 45.

The image processor 460 processes movie data read by the control unit 420 from the network DB 4 to generate images for predetermined manuals. More precisely, the image processor 460 decodes still frame images read by the control unit 410 from the network DB 4 to generate images to be presented to a user as a manual.

The print controller 470 interconnects the print device 47 and the user terminal 400, and controls the print device 47. According to the print controller 470, predetermined images corresponding to signals output from the control unit 410 are printed on a sheet.

The audio output controller 480 interconnects the audio output device 48 and the user terminal 400, and controls the audio output device 48. According to the audio output controller 480, predetermined audio sounds corresponding to signals output from the control unit 410 are output by the audio output device 48.

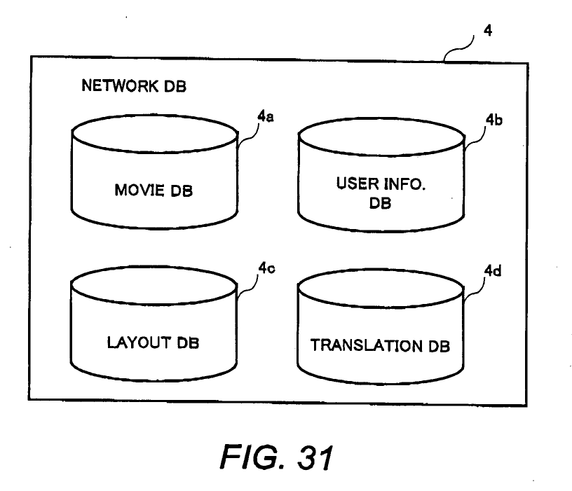

As shown in FIG. 31, the network DB 4 comprises a movie file DB 4a, a user information DB 4b, a layout DB 4c, and a translation DB 4d.

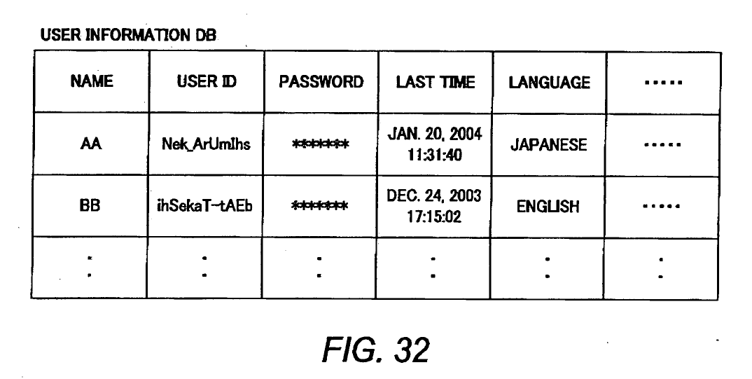

The user information DB 4b is a database for storing user information for specifying persons (users) who are able to use the manual providing system 40. In the user information DB 4b, a table as shown in FIG. 32 is prepared. The table includes, for example, user name, user ID, password, and the like being associated with each other. The user information DB 4b also stores other data such as information representing date when the user uses the manual providing system last time, and configuration data (information representing type of the manual, language, and the like when the user used last time).

The structures of the movie file DB 4a, the layout DB 4c, and the translation DB 4d are the same as those of the movie file DB 232a, the layout DB 232c, and the translation DB 232d described in the second embodiment respectively. Therefore, detailed descriptions of the movie file DB 4a, the layout DB 4c, and the translation DB 4d are omitted here.

The display device 45 comprises, for example, an LCD or the like to display various images based on the signals supplied from the user terminal 400. In this embodiment, the display device 45 mainly displays manuals generated in accordance with predetermined layout through the manual generating process described later.

The print device 47 comprises, for example, a printer or the like. In this embodiment, the print device 47 prints out manuals generated through the manual generating process described later on a sheet.

The audio output device 48 comprises, for example, speakers or the like. In this embodiment, the audio output device 48 outputs voices corresponding to guidance texts read out through the manual generating process described later.

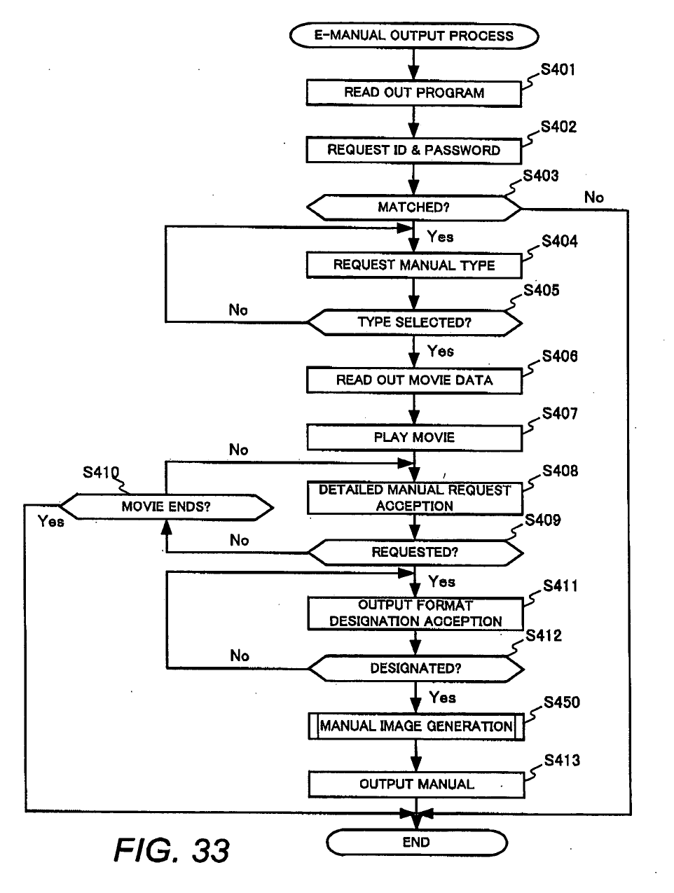

“E-manual Output Process” according to the present embodiment will now be described with reference to a flowchart shown in FIG. 33. In this embodiment, a person (hereinafter, referred to as “user”) operates the user terminal 400 to output a manual.

Once the user operates the operation unit 440 with predetermined action (for example, double click or the like) to execute the process, the control unit 410 begins to read predetermined programs from the storage unit 430 (step S401). The control unit 420 instructs the display controller 450 to display a predetermined screen for recognizing whether the user concerned is one allowed to use the system.

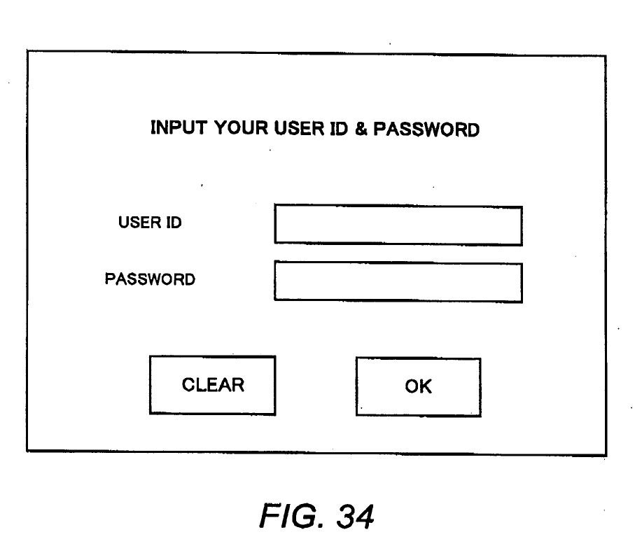

The display controller 450 controls the display device 45 to display a screen as shown in FIG. 34, thus the user is requested to input user ID) and password (step S402). The user operates the operation unit 440 to input required information in accordance with the instruction displayed on the display device 45.

The control unit 410 accesses the network DB 4 via the CCU 420 to determine whether the user ID input by the operation unit 440 is registered in the user information DB 4b or not, and whether the password is authentic or not (step S403). If it is determined that the password authentication is failed (step S403: No), the control unit 410 terminates the process.

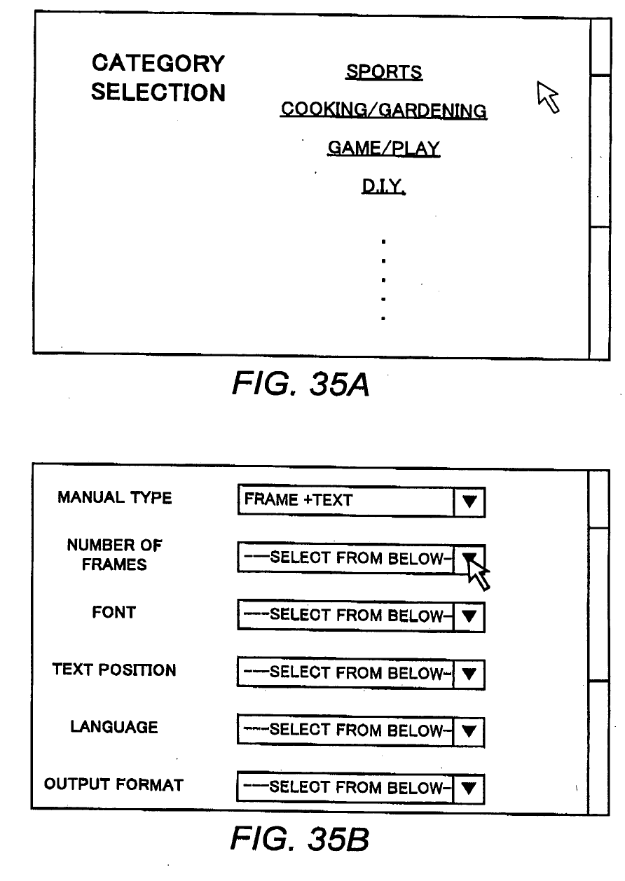

If it is determined that the password authentication is successful (step 403: Yes), the control unit 410 instructs the display controller 450 to display a screen as shown in FIG. 35 on the display device 45, thus the user is requested to select desired manual type (step S404). The user operates the operation unit 440 to select preferable manual type in accordance with the displayed image.

Since the following steps S405 to S410 are the same as steps S205 to S210 described in the second embodiment (see FIG. 16), detailed descriptions are omitted here.

If it is determined that detailed manual is requested (step S409: Yes), the control unit 410 instructs the display controller 450 to display a screen as shown in FIG. 35B on the display device 45, thus the user is requested to set output format of the detailed manual (step S411).

The control unit 410 determines whether a predetermined signal representing that the output format of the detailed manual has been set, arrives from the operation unit 440 or not, that is, whether the output format of the manual has been set or not (step S412). If it is determined that the output format of the manual has not been set (step S412: No), the process flow goes back to step S411, thus the control unit 410 continues to accept the output format setting.

If it is determined that the output format of the manual has been set (step S412: Yes), the control unit 410 carries out manual image generating process based on the information regarding the detailed manual setting (step S450).

The control unit 410 instructs the display controller 450, the print controller 470, and/or the audio output controller 480 based on the setting information received at step S412 to output the generated manual images (step S413).

According to the above-described operations, the e-manual output process is done. Details of the manual image generating process of step S450 are the same as those of the manual image generating process according to the second embodiment (see FIG. 20). Therefore, descriptions about step S450 are omitted here.

As described above, the network DB 4 on the network is helpful for flexible modification of the layout patterns or manuals. Thus, it is able to provide electronic manuals corresponding to the users' demands more flexibly.

Additionally, in a case where MFP works as the manual providing apparatus as described in the first and second embodiments, the use is able to refer to the electronic manuals regarding the: MFP through the terminal. This configuration is useful when the user is not able to refer to the electronic manual of the MFP by the MFP because of troubles or the like. According to the structure of the present embodiment, the user is able to refer to or print out the manual of the MFP through the terminal. This is helpful for quick and sure recovery of the MFP.

### Fifth Embodiment

The above-described fourth embodiment exemplified the structure wherein the terminal provides the manuals after obtaining manual data or layout data from the database on the network. Instead of that structure, a server on the network having the database may act as the manual providing apparatus which provides the electronic manuals to terminals via the network. This embodiment will describe a case where the server on the network provides manuals regarding the MFP to the terminals via the network. In this case, for example, the MFP is used in an office, and users of the MFP in the office use the terminal (for example, a personal computer, or the like) to refer to e-manuals of the MFP.

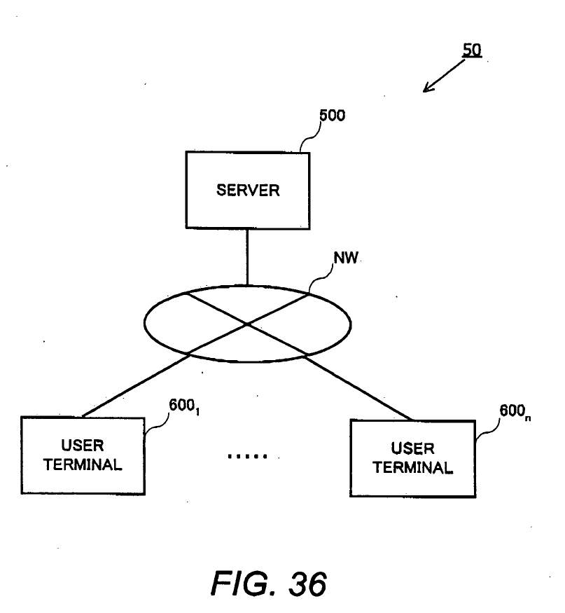

FIG. 36 is a schematic view showing the structure of a manual providing system 50 according to the present embodiment. As shown in FIG. 36, the manual providing system 50 comprises a server 500 and a user terminal 600 being connected with each other via the network NW.

The structure of the user terminal 600 may be the same as that of the user terminal 400 described in the fourth embodiment (see FIG. 30). Therefore, detailed explanation of the user terminal 600 is omitted here. As well as the fourth embodiment, the network NW may comprise, for example, PSTN, the Internet, or the like.

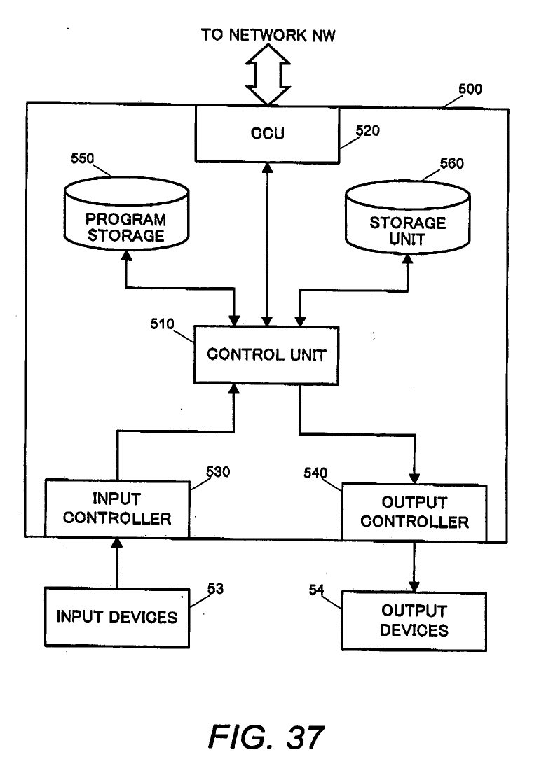

The server 500 may comprise a typical server computer, for example, a mainframe, a workstation, or the like, and may be operated by, for example, the manufacturer of the MFP. The structure of the server 500 will now be described with reference to FIG. 37. FIG. 37 is a block diagram showing the structure of the server 500.

As shown in FIG. 37, the server 500 comprises a control unit 510, a communications control unit (CCU) 520, an input controller 530, an output controller 540, a program storage 550, a storage unit 560, and the like.

The control unit 510 comprises, for example, a CPU and the like, to control whole of the server 500. More precisely, the control unit 510 executes programs in the program storage 550, thus the functions or processing described later are realized.

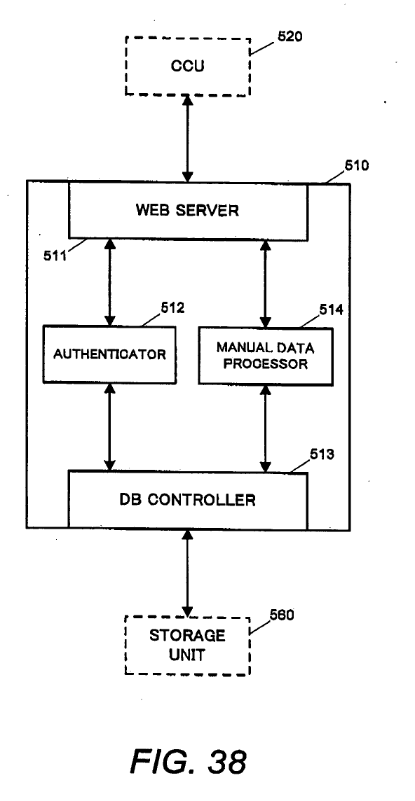

In this embodiment, execution of the programs by the control unit 510 causes the control unit 510 to act as functions as shown in FIG. 38. That is, the control unit 510 acts as a web server 511, an authenticator 512, a DB controller 513, a manual data processor 514, and the like.

The web server 511 collaborates with the CCU 520 to cause the server 500 to have web server function. According to the web server function, the server 500 accepts user demands from the user terminals 600 via the network NW, and replies to them with sending the e-manual data and the like. In this embodiment, web site provided by the server 500 works as interface to the users for providing the e-manuals to the user terminals 600 via the network NW such as the Internet. To realize such the system, the web server 511 dynamically generates web pages for the web site, and transmits the web page data to the user terminals 600 via the network NW, while receiving information input through the web pages on the user terminals 600. The web server 5 llalso selects appropriate e-manual in accordance with the authenticated user.

The authenticator 512 obtains authentication data from the user terminal 600 via the network NW to authenticate users demanding the e-manuals.

The DB controller 513 refers to information on the database 56 (described later) in response to instructions from the web server 511 or the authenticator 512. The DB controller also obtains information from the DB 56 as needed.

The manual data processor 514 processes e-manual data so as to be appropriate output format based on the user's demands.

The CCU 520 comprises predetermined telecommunications devices, for example, NIC, a router, and the like, to connect the server 500 to the network NW for data communications via the network NW.

The input controller 530 accepts input devices 53 (for example, a keyboard, pointing devices, and the like) to transfer input signals generated by the input devices 53 in accordance with the user's operation to the control unit 510.

The output controller 540 accepts output devices 54 (for example, a display, a printer, and the like) to transfers signals representing results of the processing of the control unit 510 to the output devices 54.

The program storage 550 comprises a predetermined storage device (for example, a hard disk drive, or the like) to store programs necessary for the server 500 as the manual providing apparatus according to the present invention. The programs will be executed by the control unit 510, thus the following processes will be realized.

The storage unit 560 comprises a predetermined storage device (for example, a hard disk drive, or the like) to store data necessary for the server 500 as the manual providing apparatus according to the present invention, resultant data, and the like.

In this embodiment, the storage unit 560 comprises a database (DB) 56 which is similar to the DB area 132 described in the first embodiment. As well as the DB area 132, the DB 56 comprises a manual DB 56a, a user information DB 56b, and a layout DB 56c (see FIG. 3).

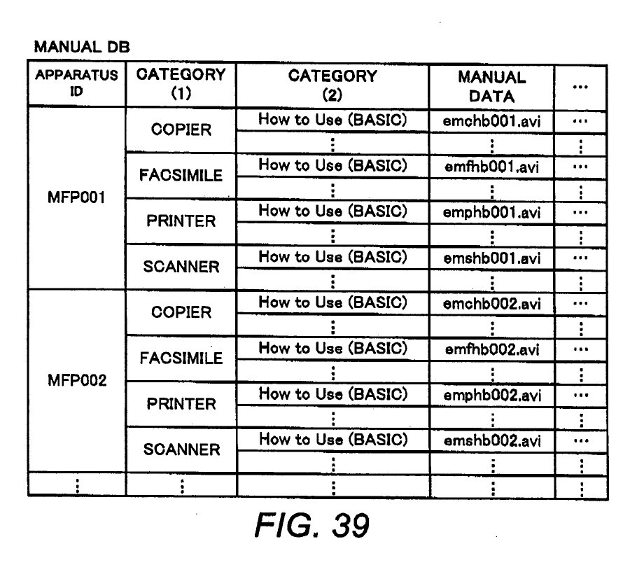

The manual DB 56a stores data for the e-manuals regarding the MFP. FIG. 39 exemplifies data stored in the manual DB 56a. As shown in FIG. 39, records corresponding to unique ID (apparatus ID) assigned to each of the MFP as primary key are prepared in the manual DB 56a. The e-manual data including movie data are recorded in each record while being categorized. The categories may be similar to those described in the first embodiment, that is, the e-manuals regarding the MFP are categorized by functions of the MFP, search indexes for the users, and the like (as well as the first embodiment, shown as Category (1) and Category (2)).

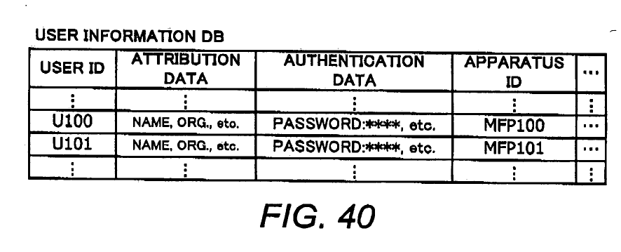

The user information DB 56b stores information regarding users of the MFP. FIG. 40 exemplifies data stored in the user information DB 56b. As shown in FIG. 40, records corresponding to unique ID (user ID) assigned to each user as primary key are prepared in the user information DB 56b. Each record includes attribute information of the user concerned (for example, user name, organization, and the like), authentication data such as login name and password, apparatus ID of the MFP used by the user concerned, and the like.

The layout DB 56c stores data regulating layout patterns of the e-manuals to be output. Data stored in the layout DB 56c may be the same as those stored in the layout DB 132c described in the first embodiment (see FIG. 7).

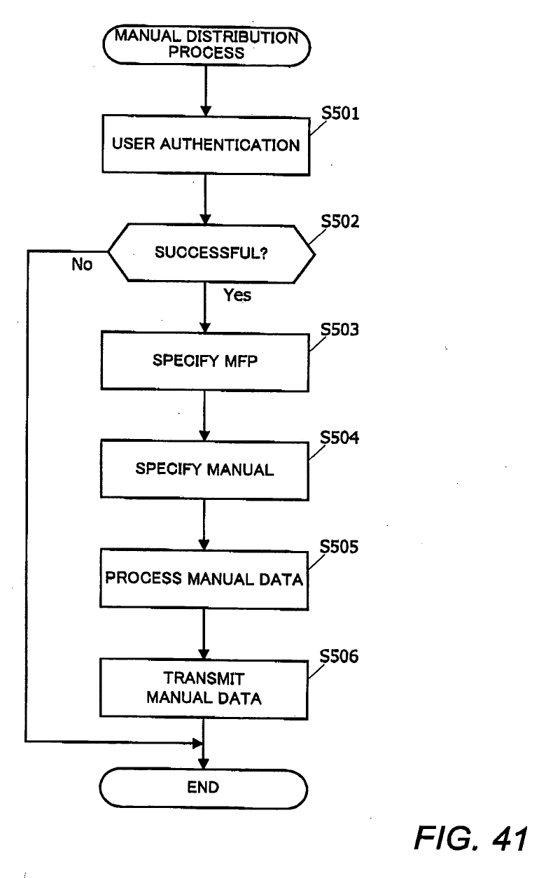

Operations of thus structured server 500 to provide e-manuals to the user terminal 600 will now be described as “Manual Distribution Process” with reference to a flowchart shown in FIG. 41. The manual distribution process may start in response to an access by the user terminal 600 to the web site prepared by the server 500 for the e-mail providing.

Once the process starts, the web server 511 generates input page for obtaining authentication data of the user, and sends the screen data (web page data) to the accessing user terminal 600 via the network NW.

The input page is displayed by the user terminal 600. The user operates the input devices of the user terminal 600 to input authentication data of the user concerned. The user terminal 600 sends the input authentication data to the server 500 via the network NW.

The server 500 carries out user authentication based on the transmitted authentication data of the user (step S501). More precisely, the authenticator 512 refers to the user information in the user information DB 56b via the DB controller 513, and authenticates the user by determining whether the given authentication data mach with the registered authentication data or not.

If the user authentication is successful (step S502: Yes), the authenticator 512 obtains apparatus 1D from the record of the authenticated user in the user information DB 56b, thus specifies the MFP used by the user concerned (step S503).

The web server 511 accesses the manual DB 56a via the DB controller 513 to find a record whose primary key represents the apparatus ID of the specified MFP. Then, the web server 511 obtains item index of Category (1) in the found record, and generates item selector page by which the items are displayed as selectable objects. The web server 511 transmits the web page data representing the item selector page to the user terminal 600 of the user concerned via the network NW.

The user terminal 600 displays the item selector page including selectable items regarding Category (1). The user operates input devices of the user terminal 600 to input desired item. The user terminal 600 transmits information representing the item selected by the user to the server 500 via the network NW.

Once the server 500 receives information representing the selected item of Category (1), the web server 511 obtains item indexes of Category (2) corresponding to the selected item of Category (1) from the manual DB 56a, and generates another item selector page by which the items of Category (2) are displayed as selectable objects. The web server 511 transmits the web page data representing the item selector page to the user terminal 600 of the user concerned via the network NW.

The user terminal 600 displays the item selector page showing selectable items of Category (2). The user selects desired item through the item selector page displayed by the user terminal 600. The user terminal 600 transmits the information representing the item of Category (2) selected by the user to the server 500 via the network NW.

Once the server 500 receives information representing the selected item of Category (2), the web servers 11 obtains manual data corresponding to the selected item of Category (2). Thus, the web server 511 specifies the manual desired by the user (step S504).

As the manual to be provided is specified, the web server 511 generates output format selector page for accepting the user's demand regarding output format of the e-manual, and transmits the web page data representing the output format selector page to the user terminal 600 of the user concerned via the network NW. The output format selector page includes various kinds of output formats corresponding to the specified manual being displayed as selectable objects. As well as the other embodiments described above, the user is able to select whether displaying the e-manual by movie play or printing the manual with frame number designation, or whether guidance text or voice are necessary or not. The user also may be able to designate desired layout of frames or texts, or language for the guidance text of voice, and the like. Those options are displayed in the output format selector page as selectable objects.

The user may select desired output format through the output format selector page displayed by the user terminal 600. The user terminal 600 transmits information representing output format designated by the user concerned to the server 500 via the network NW.

The server 500 receives the information representing the designated output format, the manual data processor 514 accesses the manual DB 56a via the DB controller 513 to obtain movie data of the manual specified at step S504, and processes the data corresponding to the output format designated by the user (step S505). More precisely, the manual processor 514 extracts frames (still images) from the movie file (movie data stream) or accesses the layout DB 56c to obtain appropriate layout data corresponding to the designated output format to process the manual data in accordance with the output format designated by the user.

The web server 511 transmits the manual data processed by the manual data processor 514 to the user terminal 600 via the network NW (step S506), and the manual distribution process is terminated.

According to the above process, the users of the MFP are able to refer to the manuals regarding their equipment (for example, MFP) with using the user terminal 600 such as a personal computer. For example, the movie style e-manuals are available as streaming through the browser for browsing web pages. In case of printing the manuals, the e-manuals are edited so as to be appropriate for printing. In this case, the e-manuals are described by, for example, HTML or the like. The users are able to print out desired manuals with using the printer or the like being connected to the user terminal 600.

According to the manual providing apparatus according to the present invention, it is able to output various manuals in accordance with the various formats desired by the user. As a result, usability of handling the electronic manuals will be improved.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments, Various modifications made within the meaning of an equivalent of the claims of the invention and within the claims are to be regarded to be in the scope of the present invention.

For example, it is obvious that the user terminal 400 described in the fourth embodiment or the server 500 according to the fifth embodiment may be realized by a single purpose apparatus. Instead of that, those apparatuses may be realized by a general-purpose computer system. Such the general-purpose computer is able to act as the user terminal 400 or the server 500 according to the above embodiments by executing the above-exemplified programs after installation.

Such the programs may be distributed arbitrarily. For example, the programs may be distributed as computer program products. In this case, the programs may be recorded in predetermined computer readable recording media such as CD-ROM. Or, the programs may be distributed via telecommunications network such as the Internet. In this case, data signal representing the computer program may be embodied in carrier wave.

This application is based on Japanese Patent Application No. 2004-41073 filed on Feb. 18, 2004 and including specification, claims, drawings and summary. The disclosure of the above Japanese Patent Application is incorporated herein by reference in its entirety.

1. A manual providing apparatus for providing electronic manuals, comprising:
a manual data retriever which obtains electronic manual data including movie data;
a designation acceptor which accepts user's designation regarding output format of the manual;
a manual data processor which processes the electronic manual data obtained by said manual data retriever in accordance with the designated output format; and
a manual output unit which outputs the electronic manual data processed by said manual data processor.

2. The manual providing apparatus according to claim 1 further comprises a database which previously stores the electronic manual data, wherein
said manual data retriever obtains the electronic manual data from said database.

3. The manual providing apparatus according to claim 1, wherein
said manual data processor extracts predetermined frame images from movie frames of the electronic manual data, and
said manual output unit outputs the manual by printing the frame images extracted by said manual data processor.

4. The manual providing apparatus according to claim 1, wherein
the electronic manual data include guidance data frame by frame, and
said manual data processor extracts frames including the guidance data.

5. The manual providing apparatus according to claim 1, wherein
said manual data retriever further comprises a layout data retriever which obtains layout data, and
said manual data processor processes the electronic manual data based on the layout data obtained by said layout data retriever.

6. The manual providing apparatus according to claim 1, wherein
said manual data retriever obtains the electronic manual data from an external apparatus via a network.

7. The manual providing apparatus according to claim 1 further comprises a user authenticator which carries out user authentication in accordance with the designated manual.

8. The manual providing apparatus according to claim 1, wherein said manual providing apparatus comprises an image forming apparatus.

9. The manual providing apparatus according to claim 1, wherein said manual providing apparatus comprises a multi function printer (MFP).

10. The manual providing apparatus according to claim 1, wherein said output unit outputs the electronic manual data to an external apparatus via a network.

11. A manual providing apparatus for providing electronic manuals, comprising:
database means for storing electronic manual data including movie data;
accept means for accepting user's demands regarding the electronic manuals;
manual specifying means for specifying electronic manual in accordance with the user's demands;
manual data processing means for processing the electronic manual data representing the electronic manual specified by said manual specifying means in accordance with the user's demands;
display means for displaying the movie in the specified electronic manual data in accordance with the user's demands; and
print means for printing the specified electronic manual in accordance with the user's demands.

12. The manual providing apparatus according to claim 11, wherein
the movie data included in the electronic manual data include predetermined guidance data, and
said display means outputs the guidance data while displaying the movie in accordance with the user's demands.

13. The manual providing apparatus according to claim 11, wherein said print means extracts frame images from the movie data in the specified electronic manual data in accordance with the user's demands.

14. A multi function printer (MFP) comprising:
a manual data retriever which obtains electronic manual data including movie data and guidance data;
a designation acceptor which accepts user's designation regarding output format of the electronic manual;
a display unit which displays the movie of the electronic manual obtained by said manual data retriever;
a manual data processor which extracts predetermined frame images and guidance data from the movie data of the electronic manual data obtained by said manual data retriever in accordance with output format designated by the user; and
a printer which prints the electronic manual represented by the electronic manual data processed by said manual data processor.

15. The multi function printer (MFP) according to claim 14 further comprises a database which stores the electronic manual data.

16. A server comprising:
a database which stores electronic manual data including movie data and guidance data;
a receiver which receives information representing user's demands from a terminal via a network;
a manual data retriever which specifies electronic manual based on the user's demands, and obtains electronic manual data representing the specified electronic manual from the database;
a manual data processor which processes the manual data obtained by said manual data retriever in accordance with the user's demands; and
a transmitter which transmits the electronic manual data processed by said manual data processor to said terminal via said network.

17. The server according to claim 16, wherein
said database further stores layout data for regulating layout pattern for printing the electronic manual, and
said manual data processor extracts predetermined frame images and corresponding guidance data from the movie data in the specified electronic manual data, obtains layout data representing layout pattern corresponding to the user's demands from said database, and processes the extracted frame images and guidance data based on the obtained layout data.

18. The server according to claim 16, wherein
said database further stores information regarding users, information regarding equipment used by the users, and electronic manual data representing manuals regarding the equipment, being associated with each other, and
said manual data retriever specifies the manual to be presented to a user based on information regarding the user concerned, and obtains the electronic manual data representing the specified manual.

19. A method for presenting electronic manuals with using a computer, said method comprising the steps of:
obtaining electronic manual data including movie data and guidance data prepared in each of frames in the movie data from a predetermined database;
accepting user's demands regarding output format of the electronic manual;
displaying the movie included in the electronic manual data in accordance with the user's demands; and
extracting predetermined frame images and corresponding guidance data from the movie data in accordance with the user's demands to print out the electronic manual in accordance with layout corresponding to the user's demands.

20. A computer program product including a computer program for causing a computer to act as a terminal computer for providing electronic manuals comprising functions of:
obtaining electronic manual data including movie data and guidance data corresponding to frames in the movie data from a predetermined database;
accepting user's demands regarding output formats of the electronic manuals;
displaying the movie represented by the movie data in the obtained electronic manual data in accordance with the user's demands; and
extracting predetermined frame images and corresponding guidance data from the movie data in the obtained electronic manual data in accordance with the user's demands, and printing the extracted data in accordance with layout corresponding to the user's demands.

21. The computer program product according to claim 20, wherein said computer program causes said computer to further comprise a database function for storing the electronic manual data.

22. A computer data signal embodied in a carrier wave for causing a computer to act as a terminal computer for providing electronic manuals comprising functions of:
obtaining electronic manual data including movie data and guidance data corresponding to frames in the movie data from a predetermined database;
accepting user's demands regarding output formats of the electronic manuals;
displaying the movie represented by the movie data in the obtained electronic manual data in accordance with the user's demands; and
extracting predetermined frame images and corresponding guidance data from the movie data in the obtained electronic manual data in accordance with the user's demands, and printing the extracted data in accordance with layout corresponding to the user's demands.

23. The computer data signal according to claim 22 causes said computer to further comprise a database function for storing the electronic manual data.

24. A computer program product including a computer program for causing a computer to act as a server computer for providing electronic manuals comprising the functions of:
storing electronic manual data including movie data and guidance data;
receiving information representing user's demands from a user terminal via a network;
specifying manual based on the user's demands, and obtaining electronic manual data representing the specified manual from the stored electronic manual data;
processing the obtained electronic manual data based on the user's demands; and
transmitting the processed electronic manual data to said user terminal via said network.

25. The computer program product according to claim 24, wherein said computer program causes said computer to further comprise functions of:
storing layout data regulating layout patterns for printing the electronic manuals;
extracting predetermined frame images and corresponding guidance data from the movie data included in the obtained electronic manual data in accordance with the user's demands;
obtaining layout data representing layout pattern corresponding to the user's demands; and
processing the extracted frame images and corresponding guidance data based on the obtained layout data.

26. A computer data signal embodied in a carrier wave for causing a computer to act as a server computer for providing electronic manuals comprising functions of:
storing electronic manual data including movie data and guidance data;
receiving information representing user's demands from a user terminal via a network;
specifying manual based on the user's demands, and obtaining electronic manual data representing the specified manual from the stored electronic manual data;
processing the obtained electronic manual data based on the user's demands; and
transmitting the processed electronic manual data to said user terminal via said network.

27. The computer data signal according to claim 26 may cause said computer to further comprise the functions of:
storing layout data regulating layout patterns for printing the electronic manuals;
extracting predetermined frame images and corresponding guidance data from the movie data included in the obtained electronic manual data in accordance with the user's demands;
obtaining layout data representing layout pattern corresponding to the user's demands; and
processing the extracted frame images and corresponding guidance data based on the obtained layout data.
